(19) United States
(12) Patent Application Publication
(10) Pub. No.: US 2016/0110669 A1
(43) Pub. Date: Apr. 21, 2016

(54) OPTIMIZING EVENTS

(71) Applicant: AJOOOBA, Inc., San Jose, CA (US)

(72) Inventor: Mangala Iyer, San Jose, CA (US)

(21) Appl. No.: 14/883,463

(22) Filed: Oct. 14, 2015

Related U.S. Application Data
(60) Provisional application No. 62/122,293, filed on Oct. 15, 2014.

(51) Int. Cl. G06Q 10/06

(52) U.S. Cl. CPC G06Q 10/06315

(57) ABSTRACT

Systems, methods and non-transitory computer-readable media for providing easy-to-use, intuitive, effective and end-to-end event management, engagement, cross-interactivity, empowerment and optimization, in association with a network-based platform that includes a user intelligence engine and an auto-matchmaking and marketing engine, to optimize aspects of providing advice, suggestions etc. to event entities, e.g. to users organizing a new event or suppliers looking to advertise, and to optimize aspects of requirements based information exchange among users as and when needed, respectively.

### CROSS REFERENCE TO RELATED APPLICATIONS

This application claims the benefit of U.S. Provisional Patent Application No. 62/122,293 entitled “Method, system and apparatus for effective event engagement”, filed on Oct. 15, 2014, and which is hereby expressly incorporated by reference in its entirety.

### TECHNICAL FIELD

The present invention disclosure is directed towards event management and, more particularly towards events optimization.

### BACKGROUND

Engaging event attendees, sponsors, exhibitors, customers, organizers speakers, etc. is a challenge. While some attempts have been made to address such challenges, there still exist huge problems in the entire event management and engagement. Most notably, an end to end solution covering the entire event value chain does not exist. Also, there is presently no solution for using past event data for optimizing future events.

### SUMMARY

Disclosed are systems, methods, and non-transitory computer-readable storage media for providing easy-to-use, intuitive, effective and end-to-end optimized event management, engagement, cross interactivity and empowerment solutions. In some embodiments of the invention, a network-based platform can provide a workspace and innovative tools for event organizers, attendees, other entities associated with an event, etc. to plan, greet, register, execute, interact, shop, gift, manage, analyze and follow up on events. In some other embodiments of the present technology, the network-based platform can include a user intelligence engine that receives event details from users of events. The event details can describe how well an event was or was not organized, executed, attended, reviewed, etc. The event details can also describe how many attendees made connections, e.g. by exchanging contact information before, during or after the event. When a new event is organized in the network-based platform, the user intelligence engine can compare new event details to past event details and optimize aspects of the new event. In yet other embodiments of the present invention, the network-based platform can include an auto-matchmaking and marketing engine that receives user details and event details, collaborates with the user intelligence engine, and optimizes the information exchange and marketing aspects between users, such as, automatically providing users with requirements based introductions and exchange of information as and when needed. Such events can be of any nature in any realm e.g. business events, such as, conferences, tradeshows, corporate meetings, etc., entertainment events, such as, concerts, movies, etc. sporting events, including, but not limited to, franchise sports, such as, major league baseball, basketball, hockey, cricket, etc. and other non-franchise sports, such as, marathons, biking, skating, etc., personal events, such as, but not limited to, birthdays, anniversaries, graduations and other parties, theme parks, and any gathering or event with one or more person(s).

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a schematic block diagram illustrating an end-to-end event management system according to some embodiments of the present technology;

FIG. 2 is a schematic block diagram illustrating an exemplary general-purpose computer system;

FIG. 3 illustrates an effective end-to-end event management, engagement, cross-interactivity empowerment and optimization system according to some embodiments of the present technology;

FIG. 4 illustrates a pre-event activities system according to some embodiments of the present technology;

FIG. 5 illustrates an event suppliers system according to some embodiments of the present technology;

FIG. 6 illustrates a communications system according to some embodiments of the present technology;

FIG. 7 illustrates during-event system according to some embodiments of the present technology;

FIG. 8 illustrates post-event system according to some embodiments of the present technology;

FIG. 9 illustrates a method and system of business card creation, storage and exchange according to some embodiments of the present technology;

FIGS. 10A, 10B & 10C illustrate a method for arranging, showcasing items and navigating in the interiors and exteriors respectively in any of the 3D virtual shops and shopping, showcases and showcasing and/or styles system according to some embodiments of the present technology;

FIGS. 10D-60 illustrate examples of interfaces for interacting with the event management system according to some embodiments of the present technology; and

FIG. 61A and FIG. 61B illustrate exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

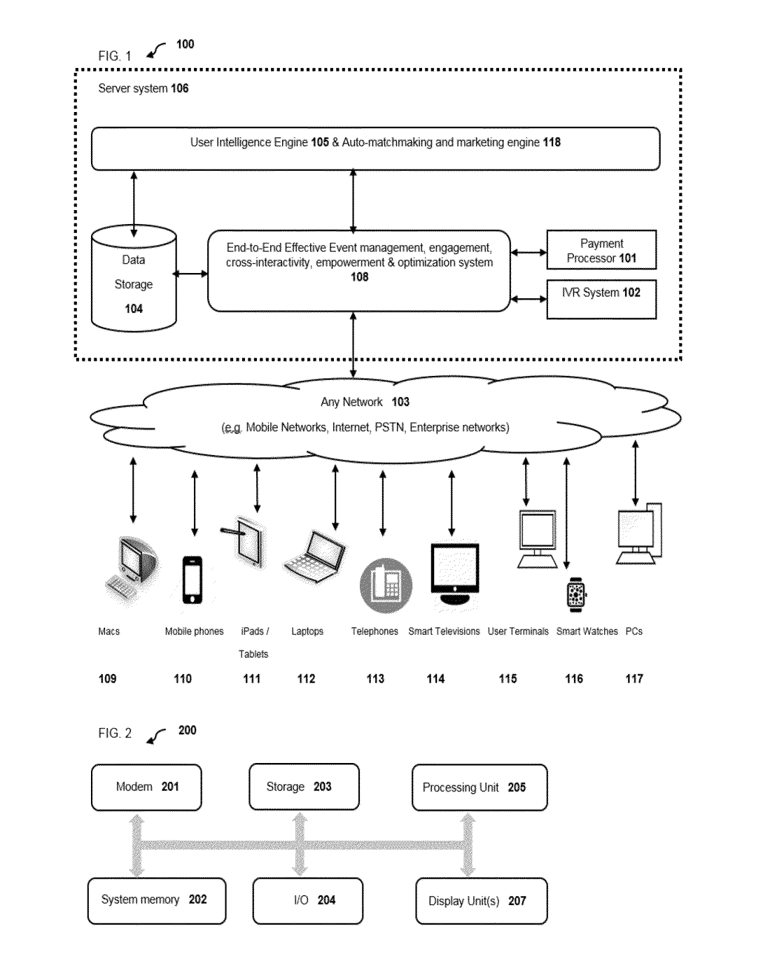

In some embodiments of the invention, the system memory (202) and storage (203) unit of the electronic systems (refer FIGS. 1&2), such as, Macintosh computers (109), Mobile phones (110), iPads/tablets (111), Laptops (112), Telephones (113), User terminals (115) and Personal Computers (117) stores computer readable instructions for implementing a viewing application such as a Web browser, e.g., Internet Explorer, Chrome, Safari, Mozilla, Opera or any other Web browser application for viewing the web pages accessible over the network. Also, the effective end-to-end event management, engagement, cross-interactivity, empowerment and optimization system (108) is operative to provide graphical user interface (GUI) screen(s) on the display unit (207) of such electronic systems by packaging predetermined web pages having user interface components encoded therein.

In some embodiments of the present technology, pre-event processes are automated in a pre-event system (302). Pre-event processes can include, but are not limited to, concept ideation, budget planning, schedule planning, venue search and finalization, short-listing and deciding on speakers, entertainers, sub-events, such as, entertainment show plans, panel discussions, inviting speakers, artists, sportsmen or other very important guests, creating artworks, banners and other marketing materials for the event, ticketing, marketing to attendees including exhibitors, sponsors and advertisers, sales of sponsor and exhibitor packages or planning other revenue generation mediums, arranging meals, accommodations, travel and other hospitality arrangements around the event days. These processes are oftentimes overwhelming for an event organizer to manage. For example, event organizers go through several meeting hours with their personnel just to brainstorm concept ideas for an event(s) and then to decide on attractive artworks and themes to associate with such event concept(s). In this embodiment of the invention as described below, all such pre-event processes are automated and presented in a streamlined, intuitive and novel way, thereby saving substantial man hours and productivity, making the event organizers happy.

The pre-event system process starts with an event organizer registering into the system using graphical user interface (GUI) screen for registration and login provided by the system (301). The user then clicks on a link provided by the system to perform pre-event activities (302) and is then directed to a screen comprising links to any, many or all of the pre-event modules comprising, but not limited to, concept creation (303), budget allocation (304), venue search and finalization (305) setting ticketing options and entry fees (311), if any, schedule and task planning (330) entering details of event(s) and sub-events (306), performing marketing functions (307), hospitality (310), sales functions (309), speakers' management (308), entertainers' management (308), creating event websites (306), setting-up event interactivity (318) setting-up virtual and hybrid events (600), personalizing user settings, performing user administration and permission control functions (356), management module to monitor all activities, view analytics/reports (358), and other links for contacting support, frequently asked questions and other company information (370). User could choose a link depending on which stage of the pre-event planning activity s/he is involved in.

An embodiment of the present invention includes Administration system/module (356), which allows registered event organization personnel to add users and provide permissions to such users within their organizations, including subsidiaries, partner or sister companies, to perform any, many, all or none of the functions mentioned above, and functions listed in the embodiments for during-event activities (313), post-event activities (320), event interactivity (318), member interactivity (319) and mobile/wearable device applications of related applications/modules/sub-modules/functions.

The administration system/module (356) comprises GUIs, such as, but not limited to, a screen for ‘Levels’ information, such as, User, Super-User, Management and Administrator, a GUI to add users along with their information about which department, sister company or partner company they belong to, first name, last name, email, phone, designation and other relevant details, a GUI to ‘Set Permissions’ comprising fields, but not limited to, User Ids, First name, Last name, Department, levels, modules, sub-modules/functions along with an ability to Grant, Revoke such permissions or Enable/Disable such users in case of department role changes or users joining or leaving organizations and a GUI to add the various departments in the organization. More sub-GUIs are provided to the organizer to view or edit the entered data. A User Intelligence Engine (UIE) (105), described in detail later, is integrated with the various functions within the system including integrations with such data points of the administration function. The system uses built-in programs, algorithms, codes, etc. to gather and store data inputs from such screens.

Another embodiment of the present invention includes, The Concept automation system/module (303), which includes, but is not limited to, an input screen for submitting concept ideas e.g. concept name, description, chosen event names for the concept in order of priority, e.g., event name choice 1, event name choice 2, event name choice 3, any artworks/images, multi-media files, etc. to associate with their concept themes, and additional notes on why they think such concept(s) would be useful. Such concept details could be submitted by as many users as the event organizer may solicit from within the registered organization. The system further provides an ability such as a link for the user to verify/validate the concept details either with an immediate supervisor or a colleague. The link further directs the user to a Verification/Validation screen comprising the fields such as, but not limited to, a check box to select either or both of Verification required from a supervisor and Just checking/validating with a colleague, selecting from a list-box of who the validation is requested from, and a text box to enter a message or change a pre-populated message, for example, ‘Please verify and let me know. If okay, kindly confirm. Thanks!’ The user selection list is pre-populated with user ids and/or user names based on permissions granted under administration with the authority to verify/validate such concepts. An email notification is then sent to the verifier with the concept details link to verify, reply with comments or confirm the concept. In addition, a Verify screen is provided by the system only those users assigned with permissions to Verify/Validate such concept submissions. The Verify graphical user interface (GUI) screen further comprises the following fields, but not limited to, viewing the concept name, description, event name choices in order of priority, for example, as event name choice 1, 2 and 3, event art work samples and any specific notes submitted by the concept creator(s). GUI screen further allows for input of Verifier notes, for example s/he could say ‘I would prefer the 1^{st} event name choice and the sample art work 4’. The system further provides links to the Verifier to either Confirm or Re-Send (with edit requests, if any) the concepts submitted. The system further provides additional links to the user who submitted such concepts to View and edit as needed and/or select multiple such saved concepts and submit at once for verification by clicking on a Verify link which directs user to the Verify/Validate GUI screen as described above. The system provides additional links to the user who submitted such concepts to view the Confirmed and Unconfirmed concepts which are provided by the system as links to the plurality of such concepts stored under each concept name as link. The system allows user to edit unconfirmed concepts by providing links to the plurality of such concept names. The system further ensures that Confirmed concepts become non-editable, and provides additional links to Re-edit such confirmed concepts as necessary. The user is prompted by the system to input the Re-edit Reason, e.g., the user could say that s/he has additional information and the system further provides a Browse and Upload links to browse any files from their computer or any electronic device in use and upload into the storage areas, which can then be accessed with link(s) on the screen for the respective file names. Once submitted, the re-edit request goes back to the verifier. The system allows the verifier to Grant, Deny, Request details, etc. on such re-edit request(s) using respective GUI links. The system then allows for editing and viewing as necessary. The system uses built-in programs, algorithms, codes, etc. to gather and store data inputs from such screens, and is integrated with the User Intelligence Engine (105) and the Auto-matchmaking and marketing engine (118) described later.

Another embodiment of the present invention, includes The budget planning automation system/module (304), which includes, but not limited to, a graphical user interface screen with input components such as, but not limited to, selecting an event, selecting/adding a category, an item within the category, quantity, unit amount, amount per quantity, currency, department for allocation and the budget in-charge. The system further provides an ability such as a GUI link for the user to either submit, cancel or verify/validate the budget details either with an immediate supervisor or a colleague. The Verify link further directs the user to a Verification/Validation screen as described above. The system further provides additional GUI links to the user who submitted such concepts to View and edit as needed and/or select multiple such saved budgets and submit at once for verification by clicking on a Verify link which directs the user to the Verify/Validate GUI screen as described above. In the View/Edit mode, the system further provides the ability to sort by any field name (or column name) and provides summation of the budget amounts by department as the default sort, which can be further customized for a summation of such amounts by any, many or all of the column/field names. The system uses built-in programs, algorithms, codes, etc. to gather and store data inputs from such screens, and is integrated with the User Intelligence Engine (105) and the Auto-matchmaking and marketing engine (118) described later.

Another embodiment of the present invention includes The Venue search and finalization system/module (305), which includes, but not limited to, a GUI screen, with input components such as, but not limited to, uploading a list of venues per a system provided format, adding venues with associated information such as name, type, address, and setting a priority, e.g. choice 1, 2 and/or 3, and additional notes, if any. The system further provides the ability to search the web for venues using built-in algorithms and programs and/or by integrating third party search providers. The system further provides an ability such as a GUI link for the user to either submit, cancel or verify/validate the venue details either with an immediate supervisor or a colleague. The Verify link further directs the user to a Verify/Validate screen as described above. The system further provides additional GUI links to the user(s) to view/edit such information, and/or select multiple such saved venues and submit at once for verification by clicking the Verify link, which directs the user to the Verify/Validate GUI screen as described above. The system uses built-in programs, algorithms, codes, etc. to gather and store data inputs from such screens, and is integrated with the User Intelligence Engine (105) and the Auto-matchmaking and marketing engine (118) described later.

Another embodiment of the present invention, includes Event(s) and sub-event(s) addition system/module (306), which includes, but not limited to, a GUI screen, with input components, not limited to, event name, event start date-time, event end date-time, event industry, description, venue name, venue type, e.g. Outdoor, Indoor, etc., venue address with city, state/province, country, event type, e.g. paid or unpaid etc., event category, e.g. Open to All, Invitation only, etc. event costs, dress code, dress advice, event classification, e.g. Premier, Non-premier, if other, input more classifications, event in-charge, other contact details, e.g. first name, last name, email, phone, submit to store the data in the system or cancel re-enter and save. The system further provides additional GUI links to the user(s) to view/edit such data including all, current, upcoming and past events, and/or events between a start and end date range. The system further provides links to direct the user to the Invitations module (312) described later to send event invitations. The system uses built-in programs, algorithms, codes, etc. to gather and store data inputs from such screens, and is integrated with the User Intelligence Engine (105) and the Auto-matchmaking and marketing engine (118) described later.

Another embodiment of the present invention, includes Speaker(s) management modules (308), which include, but not limited to, a GUI screen, with input components such as, but not limited to, selecting or adding an event, uploading a list of prospective speakers, and/or adding speaker(s) information such as speaker name, email, phone, organization, gender, designation, website, photo and contact details of any other person(s) such as a secretary or a sub-ordinate or an agency, selecting whether an internal or external speaker, invited—Yes/No and additional notes, if any, to be entered by the user. The system further provides GUI image links for the user to either submit/cancel and re-enter the form data. The system further provides additional links to the user(s) to view/edit such data and additional abilities e.g. to sort by field names. The system further provides a link to invite one, many or all of the speakers entered by making one or multiple selections and clicking on the Invite link to send the invitation. The Invite link directs the user to the Invitation module/system (312) explained in detail later. The system further provides a link to add/view/edit such remunerations entered as needed. Clicking on the remuneration link directs the user to a GUI screen, with input components such as, but not limited to, selecting/adding an event, the relevant speaker with data, such as, speaking amount, travel allowance, meals allowance, lodging allowance, any other amounts with explanations, tax identification numbers, details of any non-cash gifts, additional notes, if any, and a total of such allowances added with links to submit, cancel or verify such information entered. The Verify link further directs the user to a Verification/Validation screen as described above. The system further provides additional links to the user(s) to view/edit such data and/or select multiple such saved remunerations' data and submit at once for verification by clicking on a Verify link which directs the user to the Verify/Validate GUI screen as described above. The verifier can choose to either confirm the short-listed speakers or request for more data, and the user who submitted the verification/validation request is notified accordingly. The user can also confirm a plurality of speakers at once via another link for status check provided by the system which would direct the user to a screen, with all of the speakers' data entered into the system and a status on confirmed/unconfirmed speakers, from which a user could confirm one or more speakers by selecting and submitting using the submit GUI link. The screen further provides GUI links to cancel/clear/re-submit the selections as needed. Such confirmed speakers can be viewed in another GUI screen. The system uses built-in programs to gather and store data inputs from such screens, and is integrated with the User Intelligence Engine (105) and the Auto-matchmaking and marketing engine (118) described later.

Another embodiment of the present invention, includes Entertainer(s) management system/module (308), which include, but not limited to, a GUI screen, with input components such as, but not limited to, selecting or adding an event, uploading a list of prospective entertainers, adding entertainer(s) information such as entertainer name, email, phone, organization, gender, designation, website, photo and contact details of any other person(s)/agency such as a secretary or a sub-ordinate or any agency representatives, selecting from a category e.g. artists, sportsmen, other, etc. selecting whether an internal or external entertainer, invited—Yes/No and additional notes, if any, by the user. The system further provides abilities, such as, a GUI image for the user to click and submit to store such data in the system, cancel and re-enter the form data, and additional GUI links to view/edit such data, additional abilities, such as, to sort by field names (or column names) The system further provides a GUI link to invite one, many or all of the entertainers entered by making one or multiple selections, and clicking on the Invite link to send out the invitation. The Invite link directs the user to the Invitation system (312) explained in detail later. The system further provides a link to add remunerations and view/edit such remunerations entered as needed. Clicking on the remuneration link directs the user to a GUI screen, with input components such as, but not limited to, selecting or adding an event, relevant speakers with information such as entertaining amount, travel allowance, meals allowance, lodging allowance, any other amounts with explanations, tax identification numbers, details of any non-cash gifts, additional notes, if any, and a total of such allowances added with GUI links to submit, cancel or verify such data. The Verify link further directs the user to a Verification/Validation screen as described above. The system further provides additional links to the user(s) to view/edit such remuneration data, and/or select multiple such saved remunerations' records and submit at once for verification by clicking on a Verify link to the Verify/Validate GUI screen as described above. The verifier can choose to either confirm the short-listed entertainers or request more details. The user who submitted the verification/validation request is notified accordingly. The user can also confirm a plurality of entertainers at once via another GUI link for status check, which directs the user to a screen with such entertainers' data, and a status on confirmed or unconfirmed entertainers, from which the user could confirm one or more entertainers by selecting and submitting using image links. The screen further provides link(s) to cancel, clear and re-submit the selections. Such entertainers thus confirmed can be viewed in yet another GUI screen. The system uses built-in programs, algorithms, codes, etc. to gather and store data inputs from such screens, and is integrated with User Intelligence Engine (105) and Auto-matchmaking and marketing engine (118) described later.

Another embodiment of the present invention for the end-to-end effective event management, engagement, cross-interactivity, empowerment and optimization (108), include Registration and Ticketing system/module (31), which include, but not limited to, a GUI screen, with input components such as, but not limited to, selecting from one of the event types, e.g. main events, sub-events, virtual event, hybrid event or ubiquitous events, described in detail later, selecting or adding an event or sub-event, a provision for registration or ticket payment methods by selecting any, many or all from a plurality of service providers such as, e.g. Visa, MasterCard, Discover, American Express, Debit cards, Internet Banking, PayPal, mobile payment services and/or system's built-in payment options, displaying the cost of attendance, integrating the referral and rewards module with discount programs and logic as explained later, such as, but not limited to, selecting a discount percentage or entering a discount amount to be deducted from the cost of attendance, and further selecting the reason for providing such discounts, e.g. Group discounts, Earlybird, Season's pass, etc., adding other novel promotional offers built in the system such as, the user saying a magic word or a phrase, which offers an additional discount, by making the user input a random % between two values, e.g. between 15 and 30% or a fixed percentage value entered, or by making the user input a random discount amount between two values, e.g. between $45 and $60 or a user chosen fixed discount amount, e.g. discount of $10. Such additional discounting capabilities built-in the system can be separately provided to each of the entities attending an event, for e.g. Attendees could be provided with a word or phrase different from the exhibitors or sponsors or advertisers. Similarly, exhibitors, sponsors or advertisers could get a word or phrase different from each other. Such words or phrases could also be unique to each person attending an event of any type i.e. regular event with physical attendance, a virtual event, a hybrid event or any other. The system further includes input components to allow the user to enter as many questions as needed to be asked, customized per his/her requirements, during registration/ticket purchase by an event attendee, including any, many or all of the exhibitors, sponsors, advertisers, speakers, entertainers, and/or other guests. The system further allows the user to select whether such questions are to be asked before the registration/ticket payment or after payment, or for an invitation only event, sending such questions to the potential attendee via a communication medium, e.g. an email or a phone.

The system further includes user interface components such as, but not limited to, an image link integration with the event and/or sub-event website to perform the registration activity by any, many or all of the attendees of an event or sub-event, including exhibitors, sponsors, advertisers, entertainers and other guests. In case of an invitation only event, the system directs the user to a GUI screen to request an invitation with input components such as, but not limited to, first name, last name, organization, title, email, phone, with a user interface image for requesting invitation, which submits the data to the system, stores in relevant placeholders in the system and then retrieves and sends the invitation from the invitation system/module (312) using built-in programs, algorithms and codes. In case of a paid event, the system directs the user to a GUI screen with input components comprising, but not limited to, collecting attendee data e.g. first name, last name, organization, title, email, phone, address, event cost, attendance preference from any, many or all of physical attendance, hybrid attendance, virtual attendance and/or ubiquitous attendance explained later, number of people attending/number of tickets needed and displaying associated discounts or promotional offers as decided by the event organizer and explained above, along with available payment methods to perform the payment function using the system. The system further provides novel ways for displaying available seating arrangements and/or exhibitor booth locations, advertiser/sponsor's advertising locations in any, many or all of maps, charts, walkthroughs, each with or without interactive components for user selection in either of text, audio, video or combinations thereof including, but not limited to, 2D, 3D or multi-dimensional views including top views, side views, tilted views, rotational angled views etc. The system further provides components to view and/or download all the materials such as seating arrangements, other documents, event guides, etc. provided by the event organizer or entities associated with the event such as suppliers, exhibitors, sponsors, advertisers, etc. The system uses built-in programs, algorithms, codes, etc. to gather and store data inputs from such screens, and is integrated with User Intelligence Engine (105) and Auto-matchmaking and marketing engine (118) described later.

Another embodiment of the present inventions for the end-to-end effective event management, engagement, cross-interactivity, empowerment and optimization (108), include Marketing system(s)/module(s) (307), which include, but not limited to, a GUI screen, with links to plan, promote and track marketing activities of one or more events. The link for planning further directs the user to a screen with input components such as, but not limited to, selecting or adding an event, overall marketing budget, planned expenditure amount for email marketing, internet/radio/print/TV/other mediums of advertising, along with uploading files as needed with relevant notes, if any, to justify each of the above expenditures, and a total amount of all such expenditures. The system further provides abilities, such as, a GUI image to submit and store such data in the system, cancel and re-enter the form data, and additional GUI links to view/edit such data. The link for promotion activity further directs the user to a GUI screen with input components such as, but not limited to, templates with promotional message samples for drafting impactful emails, storing and accessing all the event related marketing communication materials (e.g. literature about the event, audio/video marketing ads, etc.), and artworks (e.g. event banners, print advertising artworks, etc.), submit to store data in the system, or cancel and re-enter the form data, or send promotional emails from within the system to a plurality of potential attendees, sponsors, guests, speakers, etc., additional abilities to view/edit/send any saved messages. The system uses built-in programs, algorithms, codes, etc. to gather and store data inputs from such screens, and is integrated with User Intelligence Engine (105) and Auto-matchmaking and marketing engine (118) described later.

Another embodiment of the present invention includes Sales system(s)/module(s)(309), which include, but not limited to, a GUI screen, with input components such as, but not limited to, selecting or adding an event, uploading a list of prospects using a format file provided by the system, selecting any, many or all of the prospect types, e.g. Advertiser, Exhibitor, Sponsor, Attendee, entering organization information such as name, address with city, state, country, industry, website address, entering a plurality of contact(s) information records in such organizations such as first name, last name, designation, phone, email, and any pertinent notes, submit, cancel. GUI links to view, edit such prospect information, direct the user to a GUI screen with a selection criteria to choose from, comprising but not limited to, selecting from event names, industries, organizations, cities, states, countries, number of records per page for e.g. 100, 500, 1000, and entering keywords, to search the system database. The system uses the selection criteria and algorithms to pull the data accordingly from the server system (106) and displays the results to the user. The system further provides links, which direct users to respective GUI screens, with input components for generating sponsorship revenues, revenues from exhibitors, revenues from advertisers, a customized package and/or combinations thereof, each detailing the cost of each package with details on what the package includes, e.g. lunch or dinner sponsorships. The system further provides a status link, which direct users to a GUI screen with input components, such as, but not limited to, selecting prospect type as any, many or all of Advertiser, Exhibitor, Sponsor, Prospect name, whether Prospect was contacted Yes or No, whether sale was confirmed, package details with any customizations and additional notes, submit to store the information, or cancel and re-enter the form data. The system uses built-in programs, algorithms, codes, etc. to gather and store data inputs from such screens, and is integrated with the User Intelligence Engine (105) and the Auto-matchmaking and marketing engine (118) described later.

Another embodiment of the present invention for the end-to-end effective event management, engagement, cross-interactivity, empowerment and optimization (108), includes Hospitality system(s)/module(s) (310) which include, but not limited to, a GUI screen, with input components such as, but not limited to, information related to travel, meals, beverages, accommodations, payments, and additional guests' such as family, significant others, friends or other traveling companions. Input components for travel information could further include e.g. selecting an event, hospitality arrangements for either of sponsors, speakers, guests, customers, entertainers or others, booking information such as, but not limited to, first name, last name, email, phone, identification documents of travelers, travel type, e.g. air, cab, train, self, bus, water, car rentals, supplier type, for e.g. direct, agency, online, travel supplier, e.g. American airlines, website information, Supplier contact information, e.g. first name, last name, email, phone, adding plurality of suppliers, class booked, e.g. regular, economy, business, first, private jet, company jet, etc., number of seats booked, amount per seat, total and other charges, whether paid or not, any cancellations, amount returned, attaching receipts and itineraries. Input components for meals and beverages further include, but not limited to, meals type, meals supplier type, meals supplier name, website data, contact details such as first name, last name, email, phone, with additional contacts if needed, number of meals booked, amount per meal, total amount, whether paid or not, number of cancellations if any, amount returned, other charges, beverages type, e.g. regular water, bottled water, soft drinks, coffee, tea, milk, other, beverages supplier type such as restaurant, catering, hotel service, private chef, other, beverages supplier name, website etc. Input components for accommodation further include selecting an event, selecting arrangement for either of speakers, guests, customers, entertainers, sponsors or others and specifying details of others, booking information such as first name, last name, email, phone, identification document numbers, adding such booking data for as many people as necessary, stay type e.g. overnight, multiple nights, day only, hourly, stay supplier type, for e.g. hotel, motel, bed & breakfast, guest house, private, stay supplier name, website address, contact information, e.g. first name, last name, email, phone, and adding such contact data of as many people as necessary, number of guests booked, class of stay, e.g. single, double, regular, special, suite, very important person rooms, other, with details of other, amount per guest, total amount, paid yes/no, number of cancellations, total amount returned, other charges, receipts. Input components for Payments include, but not limited to, selecting an event, arranging payments for either of guests, customers, sponsors or others, pay as (for e.g. per diem, actuals, Lumpsum amount), pay type (for e.g. travel only, meals only, stay only, travel+meals+stay, travel+meals, travel+stay, meals+stay, gas+mileage, all), pay to (for e.g. first name, last name, email, phone, tax id for as many people as needed, number of people, payment per person, total payment amount, paid yes/no, number of cancellations, total amount returned, other charges, attach receipts. Input components for guests include, but not limited to, adding guest names, guest type, such as, customers, entertainers, sponsors, advertisers, etc. organization with address, city, state/province, country, website address, designation of the guest, guest email, phone, etc., submit to store such information, or cancel and re-enter the form data. The system uses built-in programs, algorithms, codes, etc. to gather and store data inputs from such screens, and is integrated with the User Intelligence Engine (105) and the Auto-matchmaking and marketing engine (118) described later.

Another embodiment of the present invention for the end-to-end effective event management, engagement, cross-interactivity, empowerment and optimization (108), comprises an Event site building and event information publishing system/module (306), which includes, but not limited to, a GUI screen, with links to perform functions such as, but not limited to setting up events data, setting up sales packages, design templates for the event site and/or integrating with external sites that may be already in use. Input components for setting up events data further include, but not limited to, selecting or adding an event, uploading event logo(s), banner(s), uploading event guide/brochure/pamphlets and other event documents, uploading event photos and videos, uploading press and media coverage, posting any GUI links to important web pages and either of adding more such events data, previewing or publishing the events data by clicking on respective user interface components for performing such functions. Input components for setting up sales packages further include, but not limited to, selecting either of exhibitor, sponsor, advertiser, or any combinations thereof for whom the sales package is to be designed for, package name, package details, benefits, associated costs, any partial packages and associated costs, and contact details such as name, email, phone, of the person associated with the organization selling or co-ordinating sales of such packages with additional GUI screens with links to view and edit such data. Input components for setting up design templates for the event site include, but not limited to, selecting from a plurality of designs and/or website templates made available by the system. Input components for integrating with any external websites in use include, but not limited to, selecting any, many or all of the modules of the system mentioned in FIG. 3 and the steps involved in the automated integration with each such module using the built-in programs in the system with least minimum unavoidable human interventions that may be necessary, for e.g. if an organizer wishes to do a complete re-design of his event web-site from scratch and do the integration per additional customization requirements, s/he may contact the support personnel associated with the system for such customizations. The system uses built-in programs, algorithms, codes, etc. to gather and store data inputs from such screens, and is integrated with User Intelligence Engine (105) and Auto-matchmaking and marketing engine (118).

Another embodiment of the present invention for the end-to-end effective event management, engagement, cross-interactivity, empowerment and optimization (108) includes an Event Interactivity system/module (318) with GUI screen comprising, but not limited to, links for setting up the event interactivity for one or more events, setting-up personnel managing such interactivity and setting-up upload and download of files related to the interactivity set-up. Input components for setting up the event interactivity could further include, but not limited to, selecting or adding an event, providing the user with program codes and/or images to create direct link(s) from an event's web publishing area to the event interactivity system, providing the user with sample file formats using which event attendees' data could be uploaded into the system and retrieved as necessary. Such uploaded attendees could be further provided with user ids and/or passwords to login to the system to perform event interactivity activities. The attendees could also enter into the system using login information provided during or after registration for the event.

Once a user logs into the event interactivity system (318), the system provides a plurality of links, e.g. Attendees' information and interactions, business cards' creation, storage and exchange information (explained later in the business card system embodiment of the invention), meeting requests' exchange and meeting spots information (explained later in the meeting spots system embodiment of the invention), polls and survey’ information, speakers, sponsors, exhibitors and suppliers cross-interactivity and other information, event information, and a mall for showcasing and shopping the goods and services advertised by the various entities, for e.g. exhibitors, advertisers, sponsors, suppliers, venue providers, entertainers, speakers, etc., or anyone associated with the event, attendee notes, gallery, settings, rewards and instant communications, which direct the user to many GUI screens with input components to interact effectively.

Input components for the Attendees information and interaction area, in the events interactivity system (318), further include, but not limited to, the arrangement of attendees alphabetically by either their first name, last name, organization name, city, state, country, designation or any such field information, ability to click on any such alphabet and retrieve, view and/or edit his/her own data stored, e.g. photo, first name, last name, company information, specific needs, etc., ability to view other attendees' information and be able to add relevant notes in connection with the attendee, request the system to introduce by mouse-over or clicking on GUI image links, e.g. an Introduce Me button and/or Give Business card button, which opens another GUI component, such as a box on the same screen, a window or another screen with the sender's information including his/her business card, and allows the sender to customize the information and any message(s) to be sent to the person s/he wishes to get introduced to, a provision for the user to remember whether or not s/he met the person during the event or otherwise, e.g. met? yes/no, a provision to send meeting requests, e.g. clicking on a link, such as a link named ‘Let's meet’, which could integrate with the Meeting Spots (348) embodiment of the invention, which directs the user to a GUI component, such as a box or a window in the same or different screen, with input components for searching and suggesting meeting spots, and storing such meeting requests sent and received, a provision to send instant messages when other users are online or offline using the communications module integrated in the system.

Input components for speakers, entertainers, exhibitors, sponsors and suppliers, in the events interactivity system (318), include similar information as detailed above for the attendees, but keeps them separate while offering special GUI screens for each entity, where a plurality of records belonging to the respective entities are clubbed together and displayed in each area. This is done as an additional benefit to draw the attention of the attendees towards each such exhibitor, sponsor, supplier, entertainer, and/or speaker information available in their respective areas under such separate links/folders. The system thus provides for, and promotes, cross-interactivity among various entities associated with an event, while giving special attention to each.

Input components for event information, in the events interactivity system (318), include, but are not limited to, links for event website, event details, event photos and videos, event press articles, event documents, e.g. white papers, presentations given by speakers, research papers, or other materials, event news and updates, event announcements, event guides/brochures/pamphlets, event venue(s) with address and maps/directions, event banners/sponsor/advertiser banner(s), etc.

The event interactivity system (318) further provides the user with links including, but not limited to, those which direct the user to GUI screens for customizing personal settings, storing, viewing, sharing, editing a personal gallery of photos and videos taken during, or in relation to, the event, storing, viewing, editing personal notes taken during, or in relation to, the event, receiving and viewing notifications received in relation to the sending and receiving of introductions, business cards, meeting requests', instant messages, rewards accumulated/redeemed, etc. The system uses built-in programs to gather and store data inputs from such screens, and is integrated with the User Intelligence Engine (105) and the Auto-matchmaking and marketing engine (118) described later.

Another embodiment of the present invention, comprises a member interactivity system/module (319) which comprises all of the above as stated in the events interactivity system (318), and, additionally, customization components with a method and system specific to provide interactivity among members of an association, club, group of one or more members, e.g. in one of the many process flows of the member interactivity system (319), the system provides an authorized person with permission to register and provide login information to the members of such a group/organization, etc. with one or more members. The authorized member, or a guest member provided with such access by the system, enters the homepage with GUI components to view member information, add/edit information related to self, GUI links to the business card system (326) to perform business card activities, such as, but not limited to, create, store, exchange, share such cards, GUI links to the meeting spots system (348) to perform activities, such as, but not limited to sending, receiving meeting requests, sending/receiving meeting spots' options with additional directions and map information, performing activities related to, but not limited to, viewing, submitting and storing polls and/or survey data, and/or further integrations with the communications system (342), showcases and showcasing system (333), shops and shopping system (450), support and rewards system (357, 370), etc.

Another of the many process flows of the member interactivity system (319) could further include members of multiple organizations interacting with each other. The system provides GUI components to perform such authorization, and interactivity activities for members of multiple organizations or groups with one or more members, to interact in mutually beneficial ways. The system uses built-in programs to gather and store data inputs from such screens, and is integrated with the User Intelligence Engine (105) and the Auto-matchmaking and marketing engine (118) described later.

Another embodiment of the present invention for the end-to-end effective event management, engagement, cross-interactivity, empowerment and optimization (108) comprises a business card creation, storage and exchange system (328), with GUI components including, but not limited to, a way to login the user into the system, links to store, design, send, receive, forward, exchange business cards. While many business card applications or related inventions exist, there are several pain points and limitations in such applications or inventions. For e.g. many of the popular email services such as outlook provide storing of user data in the form of an address book, with display of some fields in a business card kind of image. However, such address books have limited use only in electronic communications such as emails or as phone books. The biggest problem that exists for people attending events is that they exchange several business cards, many of which end up getting lost as they may not have the need to be in contact at the time. However, when they might have specific needs in the future which could be addressed by any of the many such contacts made during the event, they may have already lost or misplaced such cards. Business cards made within organizations are generally representative of their visual identities such as logos, which get imprinted on such cards, and storing them as is in the form of a picture file, and being able to either type or electronically write short notes of reference, e.g. met Steve at the coffee corner during the break, could immensely help attendees to quickly remember the context of the discussion. This system offers novel ways to facilitate and automate the business cards creation, storage and exchange processes during an event, or otherwise, and overcomes the many limitations that exist in other inventions so far.

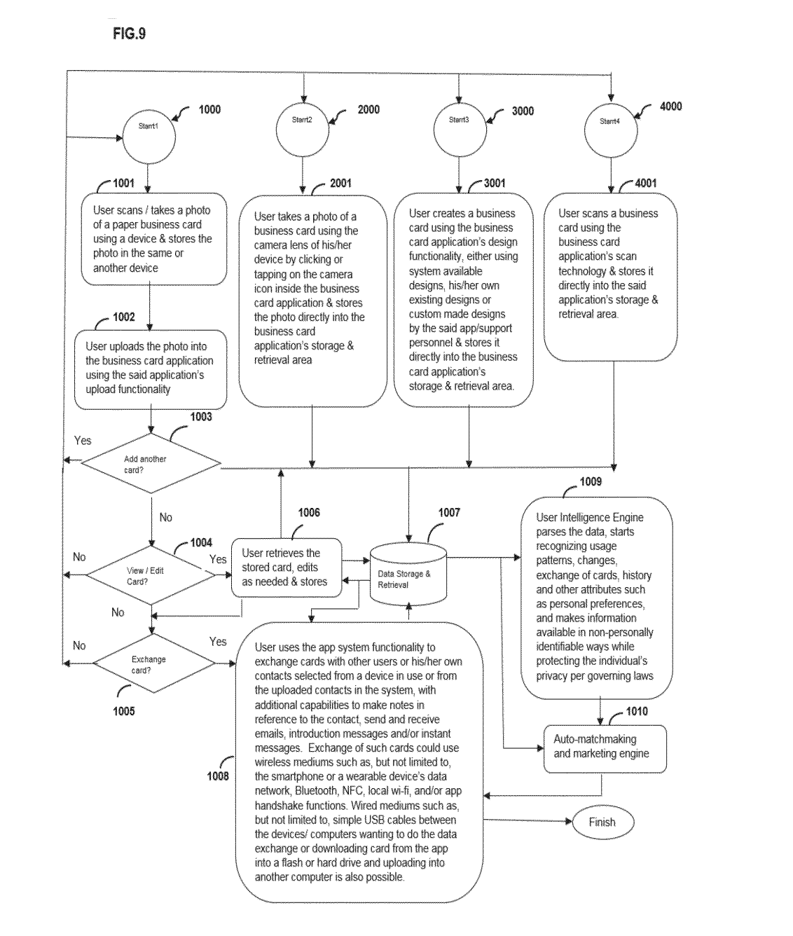

The various process flows in relation to the business card system (326) are shown in FIG. 9A. The business card design function in the system, further comprises GUI components such as links including, but not limited to, create a business card, view, edit and/or print. The business card store function further comprises GUI components such as links including, but not limited to, upload a business card, click pictures of a card, scan a card, view and/or edit such cards stored. The business card exchange function further comprises GUI components such as links including, but not limited to, sending, receiving, forwarding and storing all of his/her own cards either created or stored in the system.

In one such process flow for storing a card into this system, the system provides input components for the user to upload both the front and back side image files of a business card from a device/computer in use, and/or the system allows the user to click a picture of the card from within the system using a user interface component such as a camera icon integrated, using built-in programs, algorithms and codes, with the built-in or connected camera of the device/computer/laptop in use, and/or the system allows the user to scan the card using any of the business card scanning devices or using any mobile, a printer scanner or other devices that allow for such scanning. The plurality of data records created by scanning multiple cards can either be directly uploaded into the system or by first uploading such file(s) into a device or computer/laptop in use and then uploading into the system from such devices. The business card images and/or data gathered are thus stored into the system. The system further provides basic image editing functions, e.g. to zoom in/out, crop and re-size an image, as well as advanced image editing, e.g. adjusting contrasts, colors, brightness, etc. The system further provides a sequence of alphabets from A to Z, the user can click on any such letter and choose to store the business card under the first letter of either of, but not limited to, first name, last name, organization, title, organization, city, state or country. The system further provides an input component to label the business card before storing. The system further allows the user to either do a manual entry by providing input components, to enter business card specific data, for e.g. first name, last name, organization, designation, website, email, phone, logo, photo, address, any tag line or unique selling proposition, and/or reference notes, or auto scans the card using built-in programs and displays such data, submit to store the information, view, edit, cancel and re-enter the form data.

Another process flow for designing a card using this system includes, user interface components such as links to create, view, edit and print such cards. The create function further includes user interface components such as screens with input components to enter all of the information for e.g. first name, last name, organization, designation, website, cell phone, work phone, home phone, upload logo, photos, any background image for the card and/or selecting a background color, pattern or image from a plurality of such color palettes, patterns/background images/themes provided by the system. The system further allows for drag and drop of such field names/information as entered above, using built-in codes, algorithms and programs, on the front and/or back of the business card in positions as needed, for e.g. dragging the first name information and placing it on the top left of the front side of card, placing logo in the center of the front side of the card, or title in the top right of the front side of the card, email in the bottom left of the front side of the card, phone number on the bottom right of the front side of card, etc. The system provides GUI components for each of the front and back sides of the card where such information can be dragged and dropped into. The card thus designed can be given a name using an input component, e.g. Label As. The system further provides an ability, such as, a GUI images to submit and store the information in the system, cancel and re-enter the form data, view and/or edit. The system further provides input components for support personnel to manually design and upload such cards, as necessary.

The business cards thus stored or designed using the system can then be emailed to self or downloaded to any device in use, and/or further added to address books or signature areas, wherever possible, or sent to addresses in such address books, or any other contacts, and/or can be used in any of the communications including, but not limited to, email and mobile. The business cards thus stored or designed using the system can then be selected for printing purposes. The system further allows for GUI components such as links to print, a GUI screen with input components for selecting from a plurality of cards thus stored or designed, selecting a paper, for e.g. glossy, matt, etc. selecting a paper weight, for e.g. 100, 150, 200, 250, 300 etc., selecting a size, for e.g. standard, small, large, selecting orientation, for e.g. horizontal, vertical, etc., selecting quantity, for e.g. 100, 250 cards, etc. This system allows user to again preview the card selected and make necessary payments, using any of the many payment options that could be made available, for e.g. using a credit or debit card for payment towards printing or shipping costs. Such payments could be processed by a payment processor (101) and/or IVR (102) integrated with the system (FIG. 1).

Another process flow for exchanging a card using this system includes GUI components including, but not limited to, giving business cards, viewing the business cards received and/or sent. The business card giving function further includes GUI components to perform a simple search for a user with keyword(s), e.g. first name, last name, organization, etc. or advanced search using specific criteria, e.g. specifying city as San Jose and country as U.S.A. The system uses built-in programs, algorithms and codes to perform the search for the keywords or data specified in the selection criteria of advanced search and fetches the data accordingly. The system further provides a sequence of alphabets from A to Z, and displays such data records fetched, according to the first letter of the first name in such records by default, and highlights such letters in the sequence as an indication to the user, who can then click on each such highlighted letter and view all pertinent records pulled from the system according to the keywords or search criteria. The system also provides options to select sorting and display of such data records by either of first name, last name, organization, title, city, state or country. The user could then add an introduction message to each such data record. The system further provides a GUI component such as an image button to click and give the business card to the user(s) selected. If the card was already sent, the system gives an option to re-send. If multiple business cards are stored for the user giving his/her card then the system further sends the user to a GUI screen with input components to select any, many or all such cards to be given. The system further provides a GUI component such as a link to store the names of the users to whom the cards have been sent to, with associated information, e.g. date sent, date re-sent, label with link to the card sent, intro message etc. Similarly, the cards received are stored by the system under another GUI component for storing received cards, which when clicked, opens a GUI screen with information such as the names of the users from whom the cards have been received from, with associated information, e.g. date received, re-sent on, intro message etc. The system further provides the ability such as a GUI component e.g. an image link, when clicked can forward any of the many business cards thus received, and selected using the selection components provided by the system, to whomsoever s/he may wish to. In each of the sent, received or any other functionality within the system where multiple records are stored and displayed, the system provides capabilities to better organize such records, e.g. providing GUI components to create multiple folders, name such folders and either of drag/drop such records or select and move into such folders.

The system uses built-in programs, algorithms, codes, etc. to gather and store data inputs from such screens, and is integrated with the User Intelligence Engine (105) and the Auto-matchmaking and marketing engine (118) described later. The system further provides input components to upload address books with the user's contacts information and/or import contacts data from various sources. The business cards thus created or stored in the system can then be sent to such contacts as well, besides giving those to event attendees. The business card system embodiment of the inventions can also be carried out as an independent system to create, store and exchange business cards with personal or business contacts with or without attending an event.

Another embodiment of the invention for the end-to-end effective event management, engagement, cross-interactivity, empowerment and optimization (108) includes an innovative method and system to find accommodations (366). A process flow of the accommodations system (366) includes, but is not limited to, a user, e.g. an event organizer or an event attendee or anyone looking for an accommodation, registering into the system or entering as a guest using GUI components of the system. The system further provides GUI components, such as, a screen to select potential accommodations from a plurality of accommodation related records presented by the system either using a selection criteria, e.g. around a venue, around a hotel, around current location or around an address, specified by the user, keywords to perform a search, or input parameters given to the system using built-in programs, algorithms and codes. Such input parameters could also include integrations with accommodation providers, suppliers' module (361), etc. detailed later. The system further provides cross interactivity between organizers, attendees, suppliers and other entities associated with event(s), and ensures that best deals are made available. One purpose of this system is to be a part of the end-to-end solution in managing and optimizing events, while another is to make use of the intelligence information gathered, in ways that can be used not only for future event organizers or their attendees but also their other contacts. In addition, the system's built-in User Intelligence Engine (105) could build-up information on the user over a certain period and automatically match the user to the accommodation service providers and make suggestions to the user according to his/her past preferences in combination with current needs. Such organizers, their personnel, their attendees or any other user may use the accommodations system (366) with or without attending events, within or outside the context of such events for any reason.

Another embodiment of the invention for the end-to-end effective event management, engagement, cross-interactivity, empowerment and optimization (108) includes an innovative method and system to find meeting spots (348). One process flow of the meeting spots system includes, but is not limited to, a messaging module with GUI components using which a user can send messages to other users of the system either as a way of introducing himself/herself or as a way to request a meeting. The system further provides GUI components, e.g. a GUI image, to add potential meeting spots to the message with the system suggesting such meeting spots based either using built-in programs, including, but not limited to, those suggested by the user intelligent engine and auto-matchmaking and marketing engine, a selection criteria defined by the user, e.g. around a venue, around a hotel, around current location or around an address, keywords to perform a search for such meeting spots, integrations with information from such accommodation service providers (366), the suppliers' system (361), etc. The system further provides cross interactivity between organizers, attendees and suppliers and ensures that best deals are made available. In addition, the system's built-in User Intelligence Engine (105) could build-up information on the user over a certain period, automatically match the user to the accommodation service providers and make suggestions according to his/her past preferences in combination with current needs. One purpose of this system is to be a part of the end-to-end solution in managing and optimizing events, while another is to make use of the intelligence gathered by the system in ways that can be used not only for future event organizers or their attendees but also their other contacts. Such organizers, their personnel or the attendees may use the meeting spots system (348) with or without attending events, within the context, or outside the context, of such events for any reason.

Another embodiment of the invention for the end-to-end effective event management, engagement, cross-interactivity, empowerment and optimization (108) includes an innovative method and system to perform event(s) search (352). The innovative method herein involves search algorithms and programs to feed worldwide events data happening in geographical locations around the world collected by either crawling the web, in combination with internal events data available in the system, and/or feeding data from multiple sources, including but not limited to those readily available using marketing databases, into the system and providing such data to people searching for events, prospects and customers in ways that best market the events and increase attendance providing new sources of revenue generation, while maximizing return on investments for all parties involved. The search system further provides for either search by keywords or an advanced search method, which could be further integrated with any, many or all of the modules of the end-to-end effective event management, engagement, cross-interactivity, empowerment and optimization system. In one of the many process flows, the search system provides GUI components, including but not limited to, to make a selection between a start date, month, year, time, and end date, month, year, time, from a kind of event, e.g. technology, entertainment, sports, etc., from a sub-kind, e.g. start-ups, enterprise software, consumer and mobile world, listed under technology, etc. The search system further provides for innovative ways to arrange and display the plurality of records thus pulled from various data sources. The system uses built-in programs, algorithms, codes, etc. to gather and store data inputs from such search screens, and is integrated with the User Intelligence Engine (105) and the Auto-matchmaking and marketing engine (118).

Another embodiment of the invention for the end-to-end effective event management, engagement, cross-interactivity, empowerment and optimization (108) is a notes system (353) to empower a user to take notes during an event using this system, and to collaborate, edit or exchange those with any or many users with or without attending an event, with additional capabilities including but not limited to customizing, editing, auditing, querying and reporting. This could additionally include any or many of, storage, retrieval, embedding, backend event administration and management including collaboration abilities among users with customizable permissions settings including view, edit, save, delete, and display of such data in multiple placeholders across any system including transporting such data via emails to users or to third party servers. The main purpose of this system is to ensure that any notes made by a user, pertinent to an event, remain stored in the central repository of that event so that the user can retrieve in the future whenever s/he wishes to. While many notes applications or related inventions exist, there are several pain points and limitations in such applications or inventions. For e.g. a user may take such notes using any such application in his/her device/computer but may soon change the device, or may not use the service provider of any of the internet storage services if stored there, or may not remember the folder or document where the event specific notes where jotted down, or in which hard drive those were stored, or spend countless hours unnecessarily searching for a small piece of notes, mostly manually written on some paper notepads which is what most event organizers provide. Hence the notes system (353) provides for an electronic note taking ability where a user can use either of, including but not limited to, keyboards, key pads, touch pads, or other digital writing devices, e.g. stylus, or simply a finger, and save such event specific notes in the central repository of that specific event that can be instantly found.

One such process flows of the notes system, when integrated within an event interactivity system, provides for a GUI component such as a link for my notes, which when clicked, opens another GUI component such as a screen with html and/or text editing and designing capabilities, which can be saved as, viewed or edited later as needed using the input components of the notes system provided for such actions. The notes system further provides GUI components comprising, but not limited to, downloading such notes, collaborating on such notes with others, and/or transmitting such notes through electronic mediums, e.g. emails and/or messenger services, etc. The notes system further provides GUI components such as small notes icons, which can be integrated in any GUI component of the end-to-end event, which when clicked starts the process flow as described above of opening the graphical user interface component such as an html/text editor for writing/typing/notes which can then be saved, viewed, edited, retrieved. The system uses built-in programs, algorithms, codes, etc. to gather and store data inputs from such GUIs, and is integrated with the User Intelligence Engine (105) and the Auto-matchmaking and marketing engine (118) described later.

Another embodiment of the invention for the end-to-end effective event management, engagement, cross-interactivity, empowerment and optimization (108) includes an innovative method and system to manage an event gallery (329) in such a way that the gallery becomes a central repository of all photos and videos in relation to any event around the globe. The main purpose of this event gallery system (329) is to ensure that any photos and/or videos made/taken by a user or an event organizer, pertinent to an event, remain stored in a central repository for that event media, so that the user can retrieve those in the future whenever s/he wishes to. While many photo/video applications or related inventions exist, there are several pain points and limitations in such applications or inventions. e.g. a user may be interested in either viewing some photos or video presentations of some speakers from a business event at some future date. However, very few organizers, depending on the size of the event, manage to retain their event websites beyond the day of the event with such photos/videos. Even if they do so, they may lack sophisticated tools to upload, download, stream or keep such media over extended periods such as several years. Some organizers try to use many of the openly available video sites but fail in fulfilling their audience's needs and expectations, and most lose out on the audience satisfaction index with irrelevant advertisements popping up on such sites, besides those being so broad with consumer videos mostly, that there isn't much focus on the careful attention a business event's content deserves for the attendees' huge investments, e.g. event costs, travel costs, hotel costs, investing productive man hours, etc.

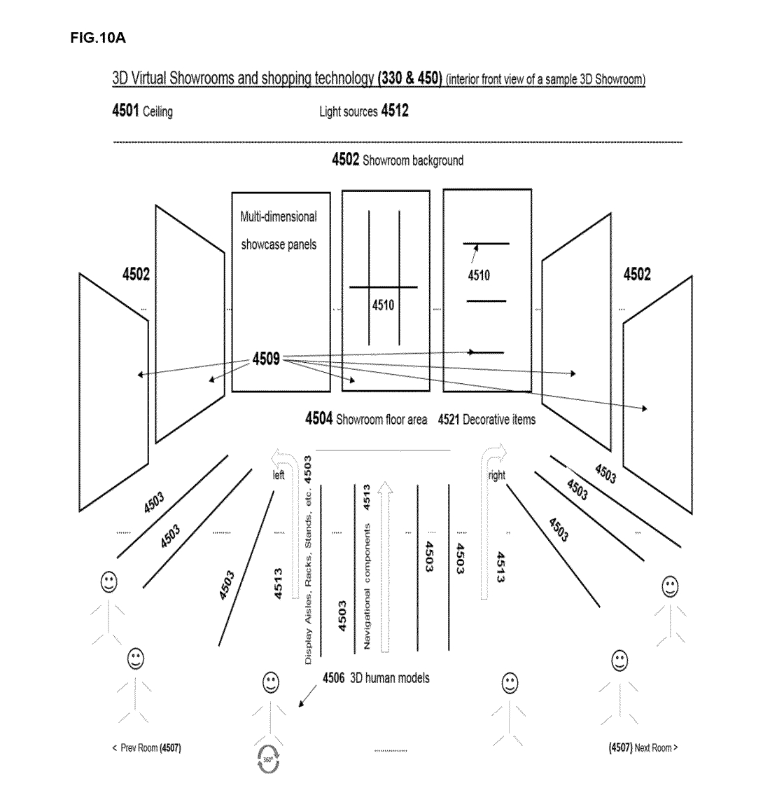

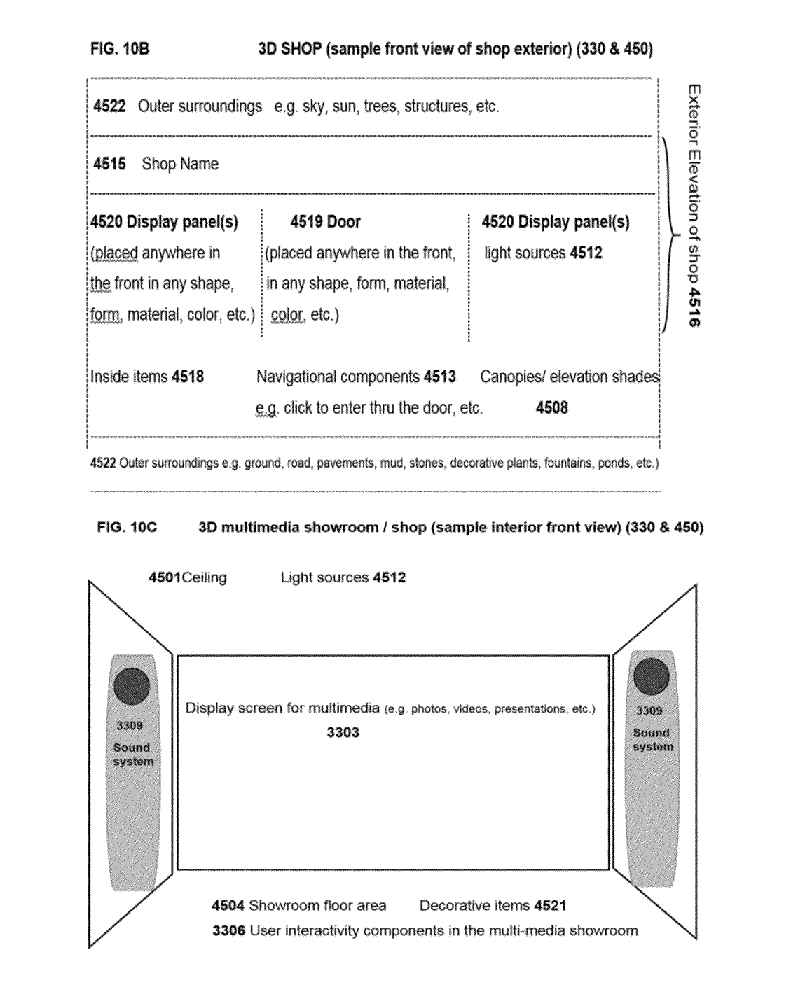

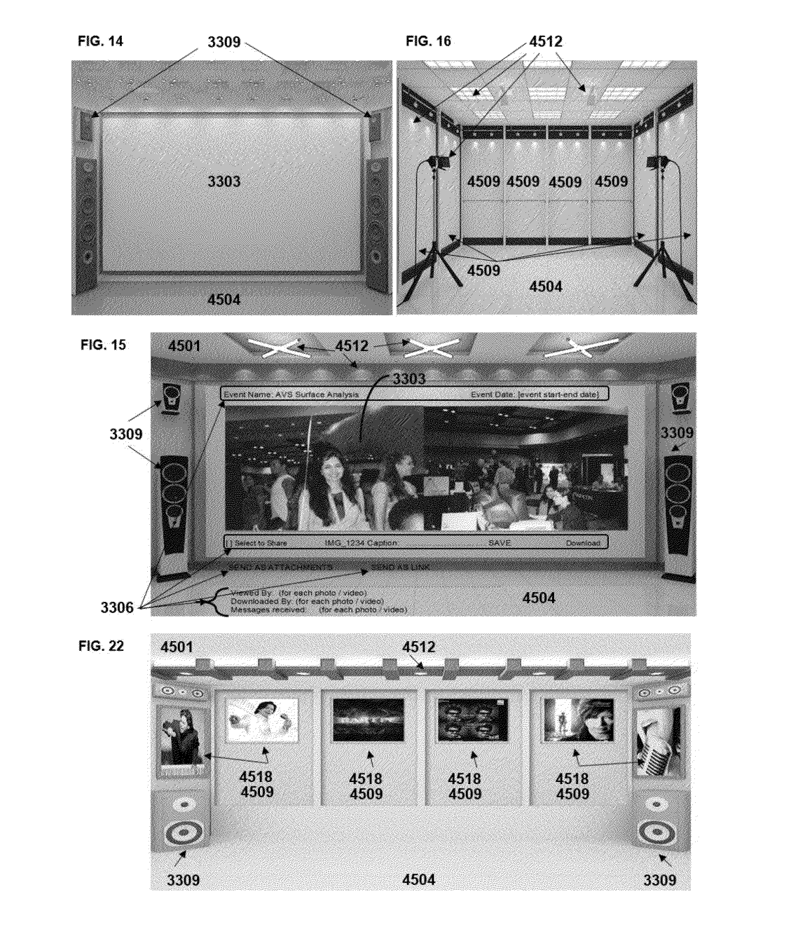

One of the many process flows of this embodiment of the invention for an event gallery system (329), provides for GUI components, such as, a link for an event gallery in as many user interface screens of the end-to-end effective event management, engagement, cross-interactivity, empowerment and optimization system (108). Such a link is further integrated with the events gallery system, which can also be carried out as an independent system to perform event gallery activities such as, including but not limited to, to create, store, upload, write captions, messages, download, print, view and exchange photos, videos or other files, including but not limited to, multimedia presentations (FIG. 10C), search and/or share such media and/or other files with their personal or business contacts who may or may not have attended such events, etc. The events gallery system further allows users to subscribe to such event photos/videos/presentations/media/files based on a selection criteria input by the user. The system sends such requested information either as links to such media/files, or the media files, through the built-in or integrated communication mediums, including but not limited to, emails, phone messages, messenger services, etc. which when clicked can be viewed by the users, downloaded, shared, and/or exchanged with any of their personal or business contacts. The events gallery system further provides GUI components to upload such address books or phone contact lists from any of the many devices or service providers of the users. The events gallery system further provides GUI components (3306), for the event attendees or any other person associated with a business event or their contacts or invitees to perform event gallery activities such as, including but not limited to, to create, store, upload, write captions, messages, download, view, share and exchange photos, videos or other files, including but not limited to, multimedia related to their personal events as well besides business, professional or other events, for e.g. birthdays, graduations, festivals, family get togethers, parties, weddings, anniversaries, outings, attending concerts, sporting events, movies, etc. FIGS. 14, 15, 16, 17, 22 show a display screen (3303) with electronic speakers/sound system (3309).

Event gallery system (329) could be further integrated with third party systems, other software(s) or service(s), the showcases and showcasing system, and/or the shops and shopping system, of the end-to-end effective event management, engagement, cross-interactivity empowerment and optimization system, by providing GUI components such as, but not limited to, providing links to the respective systems to allow professional service providers, (besides event organizers, exhibitors, attendees and their contacts, or other users of the system) such as, but not limited to, professional photographers, videographers, art collectors, gallery owners of paintings, sculptures, or other collections, to offer innovative ways for viewing and/or buying. The system uses built-in programs, algorithms, codes, etc. to gather and store data inputs from such GUIs, and is integrated with the User Intelligence Engine (105) and the Auto-matchmaking and marketing engine (118) described later.

Showcases and showcasing module/system (333) is yet another embodiment of the invention for the end-to-end effective event management, engagement, cross-interactivity, empowerment and optimization (108) which includes an innovative method and system to manage the processes of designing showcases/display areas and placing items/objects for the purposes of displaying/showcasing, either inside an online shop or otherwise. The main objective of the showcases and showcasing system is to ensure that any photos and/or videos made/taken by a guest user, a registered user, an event attendee, an event organizer, etc., of any merchandise, any goods or services of professional service providers, exhibitors, suppliers, or any other parties associated with an event, are given sophisticated, aesthetically pleasing and most novel ways to exhibit their collections to generate a wow factor among the viewers while making associated shopping experiences, swift and easy, maximizing sales for the sellers, or viewing eyeballs for the showcasers, and return on investments for the users of such systems, including but not limited to, the event organizers and associated entities such as their exhibitors, attendees, sponsors, advertisers, venue providers and other suppliers, movie production houses, concert organizers, theme park owners, franchise and non-franchise sports organization owners, sportsmen, movie stars, singers, songwriters, actors, artists, painters, professional photographers, museum owners, etc. While many gallery or showcasing applications or related inventions exist, there are several pain points and limitations in such applications or inventions, e.g. the display of pictures as tiles or slides, have become too common and most boring to view, which is what most prior arts talk about. Also, most of the c-commerce sites only offer selections from a plurality of items for sale, with a display of such photos as tiles, with the associated price and description, then to be selected/added to cart to buy.

One of the many process flows of this embodiment of the invention for the showcases and showcasing module/system (330) include GUI input components, such as, but not limited to, selecting and/or customizing one or more of the many multi-dimensional designs, such as, 3D showroom designs, e.g. 3D interiors (refer. FIGS. 10A, 10C), 3D exteriors (FIG. 10B), 3D outer exterior surroundings (4522), e.g. compound walls, designs showing footsteps, fences, gates, bushes or other landscape, seascape, skyscape designs, selecting one or more kinds of exterior structural, shape designs, including exterior elevations (4516) e.g. a square, circular, diamond or any such shape, selecting one or more structural, shape designs for entrances, selecting one or more of the many materials to be used in such designs, including but not limited to, for structures e.g. cement, metal marble, etc., selecting one or more of the many colors for any such design, including those for designs of structures, e.g. a silver gate, shades or canopies (4508) in exterior elevations, selecting and/or customizing one or more of the many showcasing arrangements, e.g. in aisles, on walls, in glass cases, in shelves/item holders (4510), on models, (4503) etc. selecting and/or customizing one or more of the many floor (4504) designs, ceiling (4501) designs, using different light sources (4512), walls, windows, pillars or other showroom background (4502) designs, showcasing kinds (4509), e.g. any or many of multi-dimensional showcases, display panels (4509) or stands (4503), hangers (4503), hooks (4503), etc., selecting one or more of the many ways to name and/or add a price (4514) to such show case panels, e.g. virtual labels, tags, stickers, plates, boards, etc., providing movement components (4524) to a singular or plurality of panels, e.g. rotational, revolving, tilting, sliding, and/or selecting from one or more of the many 3D virtual mannequins/human models (4506), aisle racks, hangers, stands, hooks, etc., to display a plurality of items (4518), selecting a count of each of the above, such as, 9 showrooms, 6 showcases inside each selected showroom, 100 showpieces/items, etc., selecting zoom options, view options, such as, left side view, etc., providing navigational components (4513) for movements inside such virtual showrooms, e.g. clicking on a left arrow sign either drawn on the floor or shown on sign boards or otherwise, could move the user to the left side of the room, a straight arrow sign could move the user straight ahead, a right arrow sign could move the user to the right, GUI components (4507) move users to the previous room or next room, and so on, uploading, editing, downloading objects/items/showpieces, adding showpieces to favorites (4511), sharing, uploading, downloading, entering data from address books and/or other contacts, entering, sending, receiving and/or sharing messages, sharing showrooms and/or selecting and sharing any, many or all of the showcases from any or many showrooms, etc., selecting one or more such items showcased and adding to carts, baskets or any such storage components (shown other icons (4505) as GUI components for performing such user interactivity associated with the showpiece items (4518) mentioned). This system could additionally include using such mannequin/virtual human models (4506) in 3D/multi-dimensional format for a more immersive and interactive shopping experience in case of clothing, merchandise and other accessory/retail sales where users could use the system to either showcase their materials on the human models they will be allowed to pick, or create any multi-dimensional models to try such items on such models or virtual figurines before purchasing. This could further include a 360 degree view of such virtual models, figurines or mannequins wearing or holding such items with added functions and features to input or adjust for height, weight, body dimensions, and/or facial features to match that of the user. This could additionally include customizing, editing, auditing, querying and reporting, and any or many of storage, retrieval embedding, backend event administration and management including collaboration abilities among users with customizable permissions settings including view, edit, save, delete, and display of such data in multiple placeholders across any system including transporting such data via emails to users or to third party servers. The showcases and showcasing system/module could further include showrooms and/or showcases designed specifically by category, for e.g. music showcase(s), music showroom(s), book shelves, books showroom(s), multi-media showcase(s), multi-media showroom(s), automobile showroom(s), etc. FIG. 10C shows an exemplary embodiment of a multi-media showroom with a display screen (3303) for multimedia e.g. photos, videos, presentations, etc. with a surround sound system (3309) and other user interactivity components (3306) to perform view, share, store, etc.

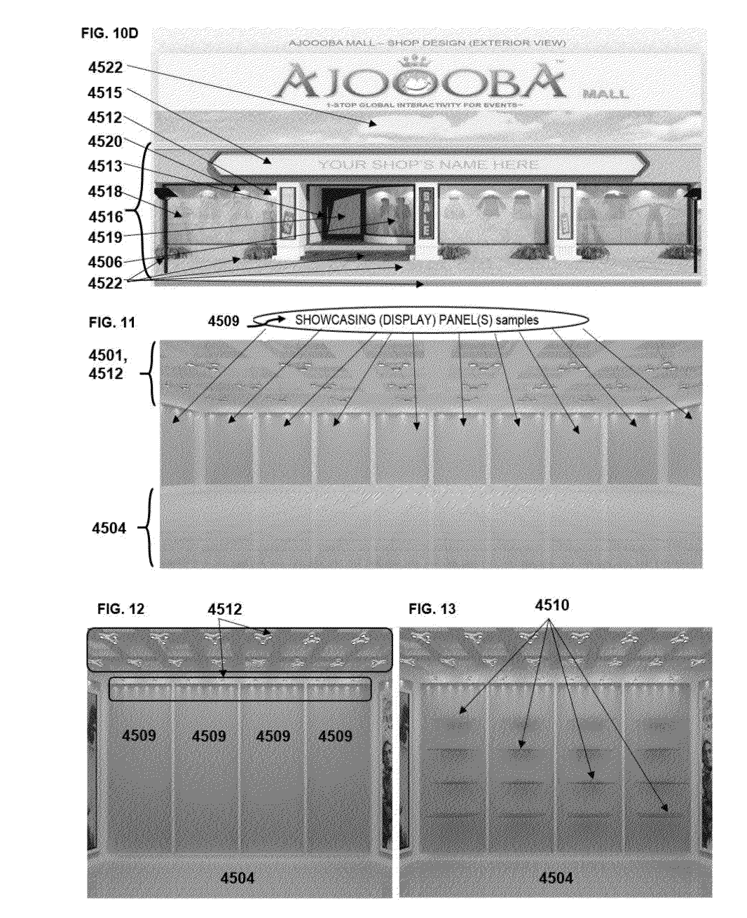

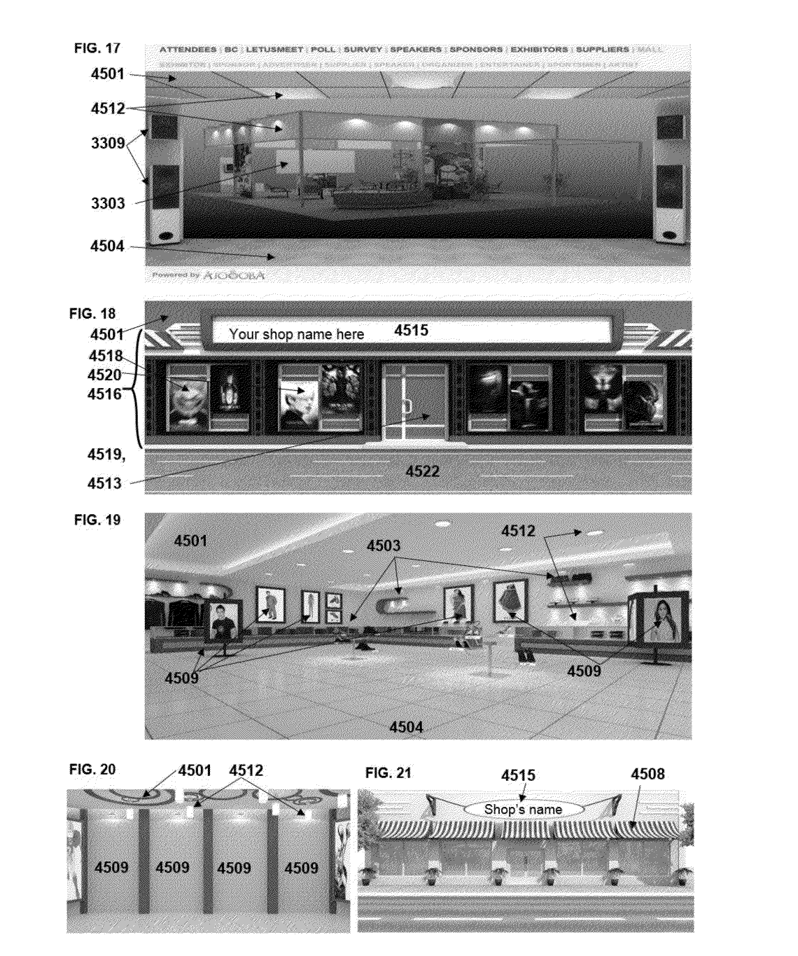

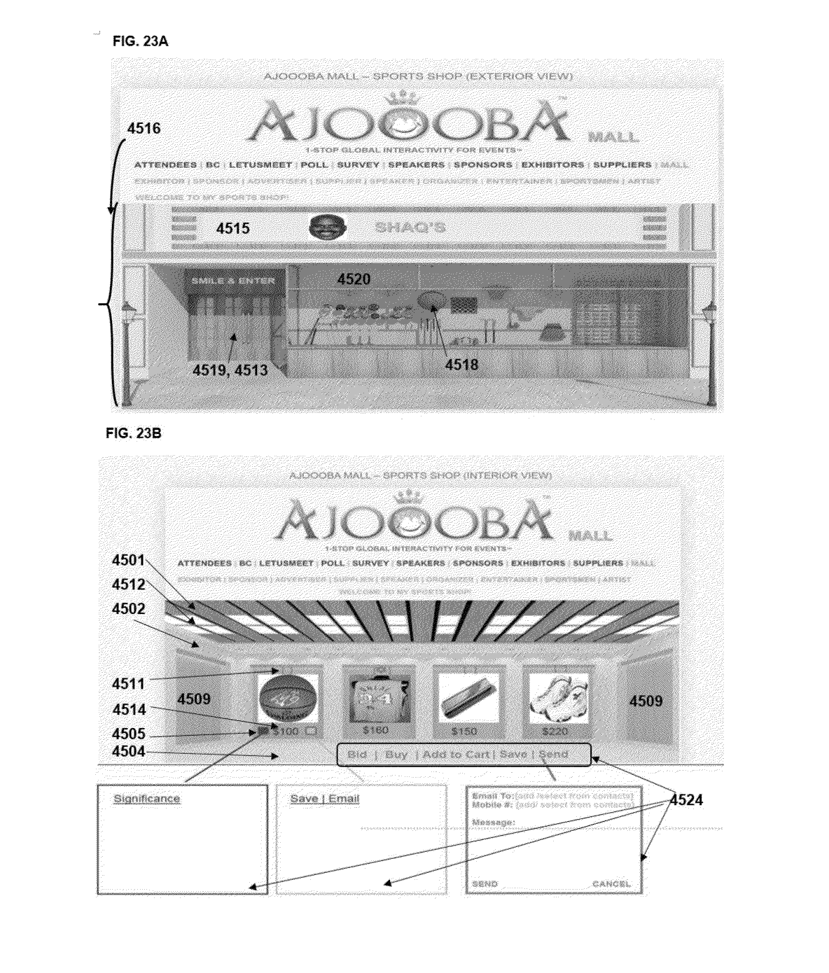

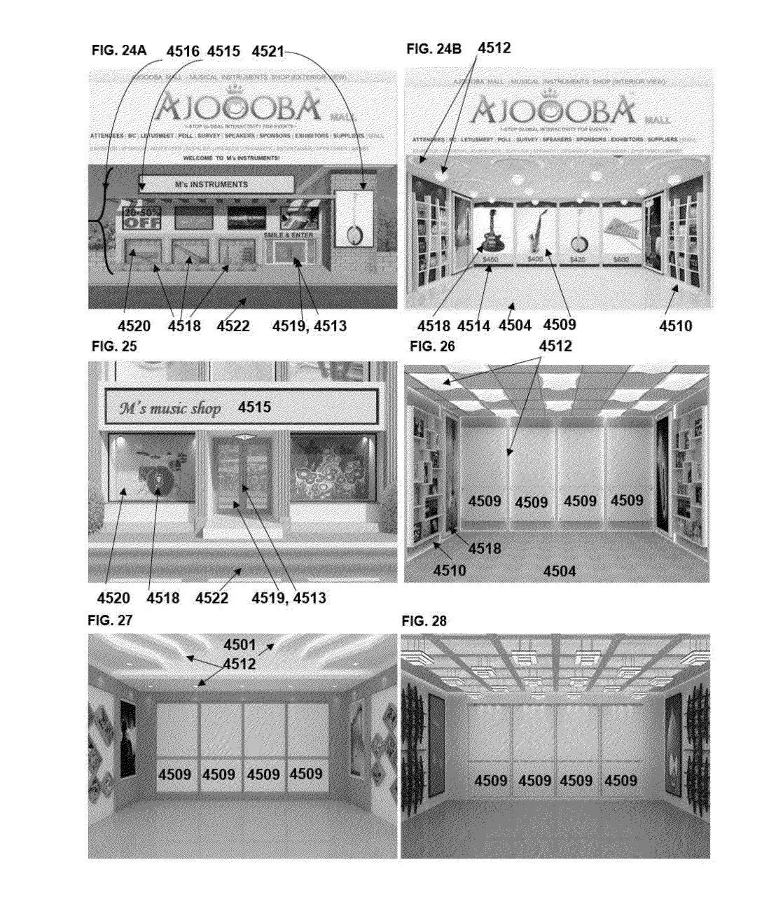

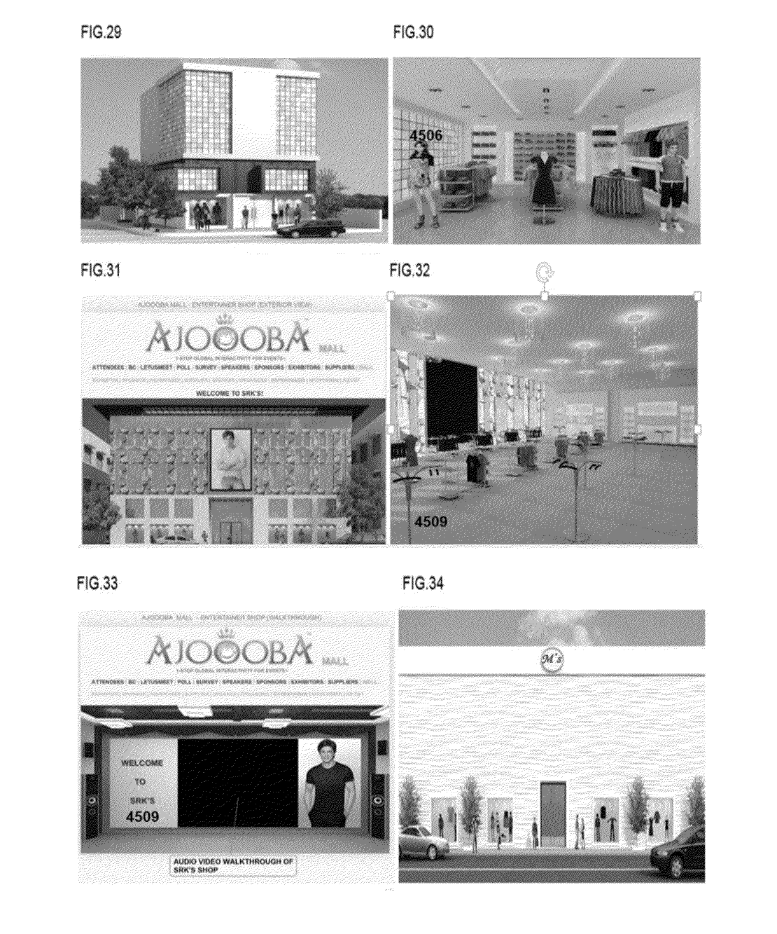

Refer FIGS. 10A, 10B, 10C, 10D to 51 for various sample embodiments of the shops and shopping system (450), showcases and showcasing system (330), and the styles system (338). FIG. 10A illustrates an exemplary embodiment of 3D/multi-dimensional showroom, which can also represent an interior of a 3D/multidimensional shop. FIG. 1 OD illustrates an exemplary 3D exterior view design for an interactive multi-dimensional shop. FIG. 11 illustrates an exemplary 3D interior view design showing plurality of exemplary showcasing/display panels (4509) in an interactive showroom for the shop in FIG. 10D. FIG. 12 illustrates an exemplary 3D interior view design showing the exemplary showcasing/display panels (4509) in FIG. 11 in a zoomed view. FIG. 13 illustrates an exemplary 3D interior view design showing the exemplary showcasing/display panels (4509) in FIG. 12 with exemplary showcase item holders (4510), such as, glass plates/shelves. FIGS. 14, 15, 16, 17, 22 illustrate exemplary 3D designs for interactive multi-media showcasing similar to the embodiment illustrated in FIG. 10C, such as, but not limited to, photos, videos, audios, and any combinations thereof. FIGS. 18 and 19 illustrate exemplary 3D exterior view and interior view for a multi-dimensional shop using red colored theme with plurality of items (4518) displayed in showcases (4503,4509) in multiple shapes, kinds and sizes, shown here as auctioning/selling movie merchandise. FIG. 23A and FIG. 23B illustrate an exemplary 3D exterior and interior view design respectively for an interactive sports shop with plurality of items (4518) displayed in showcases (4503,4509) in multiple shapes, kinds and sizes, shown here as auctioning/selling sports goods. FIG. 23A shows a door (4519) on the left which when clicked (4513) could let the user inside the shop, and into the showroom interior as shown in a zoomed in view in FIG. 23B. FIG. 23B also shows pricing (4514), interactive user interface components, such as, colorful icons (4505) which, either on mouse-over or on click, could show GUI components (4524) to show significance, features or other such details of each product displayed, to save, email, share images with friends/contacts, bid, buy, add to cart, etc. FIG. 20 shows another room which could be inside a sports shop of FIG. 23A, or any other shop, with a different interior décor, light sources and showcase panel (4509) designs from the ones in the showroom of FIG. 23. FIG. 21 shows a unique way to hang the shop name board (4515) on the top and use of canopies (4508) in the exterior view of an exemplary 3D shop. FIGS. 24 to 28 illustrate exemplary 3D view designs for music and musical instruments related interactive shops. FIG. 24A shows a sample exterior view of a musical instruments shop with a door (4519) with GUI component to enter (4513) the showroom inside as shown in the sample FIG. 24B showcasing the musical instruments (4509) in the middle, posters on either side and shelves (4510) with music related products and services. FIG. 25 shows an exterior view with a door (4519) with GUI component to enter (4513) into either of the sample showrooms shown in FIG. 26, 27, 28 or any other. FIG. 22 shows music demonstration room where any of the music displayed could be played and listened to with the electronic speakers (3309) on both sides adding the requisite sound effects. FIGS. 26, 27, 28 each shows an interior front view of a showroom with empty display panels (4509) in the middle of the room with multiple light sources (4512) in the ceiling (4501) for showcasing any items or related information, and posters or other products on the shelves (4510) on both sides. FIGS. 29 and 30 show a sample exterior view and an interior view of interfaces for a clothing and accessories related shop.

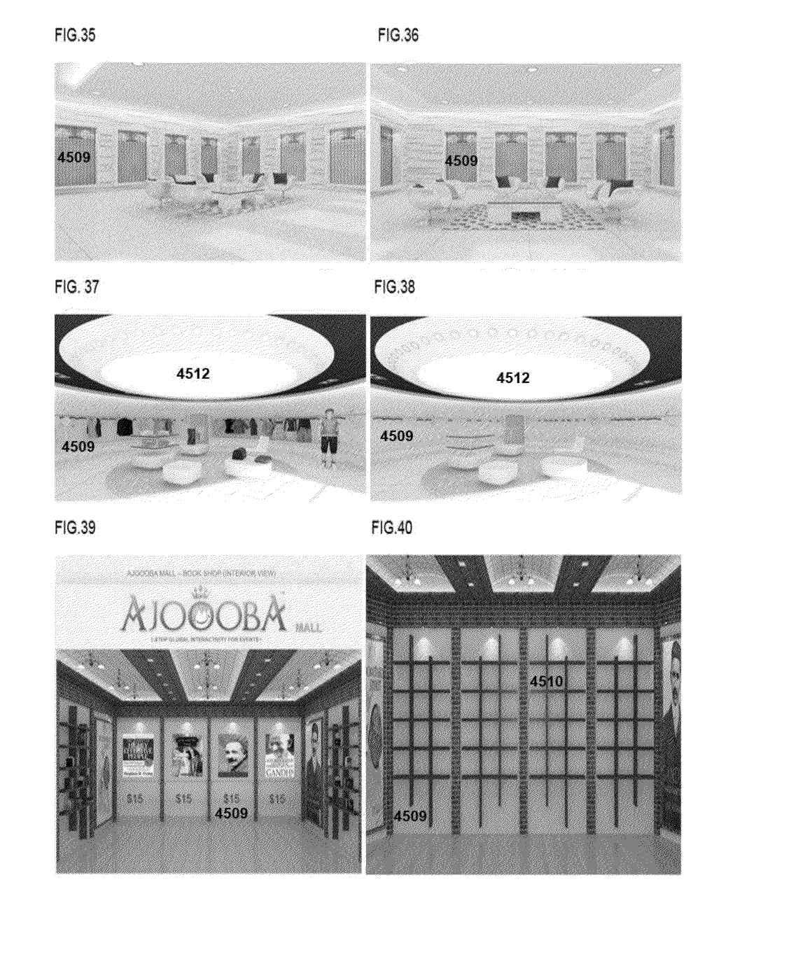

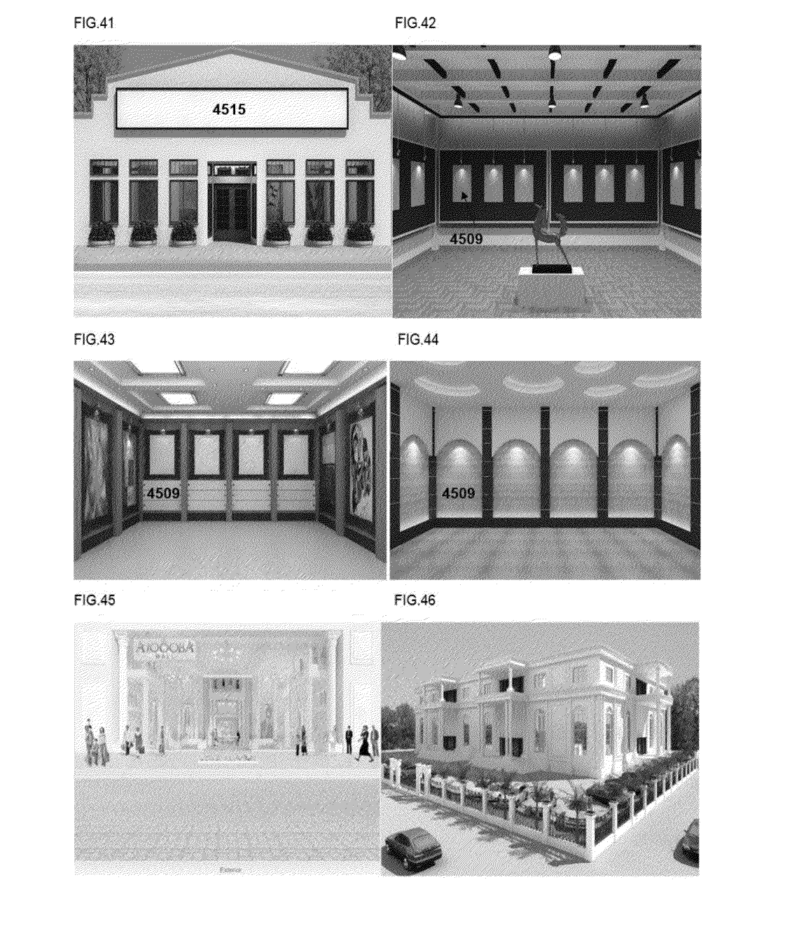

FIGS. 31, 32 and 33 illustrate an exemplary embodiment of 3D shop view designs for an entertainer's interactive shop. FIG. 31 shows an exterior view of a shop using colorful stained glasses theme with the shop owner actor's poster above the entrance door, glass display panels with merchandise, people going in and out of the shop, vehicle, trees, buildings, etc. FIG. 32 shows inside view of the shop with sunlight coming in through the stained glasses, merchandise display aisles, racks, stands, etc. FIG. 33 shows a multi-media 3D interactive design view with speakers and a screen in the center giving a movie theatre effect to show an audio-video walkthrough demonstration and/or other photos or videos. FIGS. 34, 35 and 36 illustrate exemplary 3D interface designs for an interactive shop using cement/clay as primary materials with decorative lines in wall structures/elevations and painted white. FIG. 34 shows an exterior view that includes an oval placeholder for shop name at the top, a metal entrance door, glass displays showing merchandise on 3D models, people, road, decorative plants, car, etc. FIGS. 35, 36 show interiors including sitting arrangements and wall display panels with hangers. FIGS. 37, 38 illustrate exemplary 3D interior designs for an interactive circular shop using a circular theme showing circular ceiling light sources, circular carpet on the floor, circular walls with circular rods fixed for clothe hangers. Refer FIGS. 39, 40 for sample embodiments of 3D interface designs for books related interactive shops including highlighting lamps above each book, posters, shelves, pricing details, etc. FIGS. 41, 42, 43 and 44 illustrate exemplary embodiments of 3D shop designs for an artist's gallery or a museum of collectibles. FIG. 41 shows an exterior view with a door through which a user can enter into any of the many gallery rooms inside shown in samples FIG. 42, 43, 44, and keep photos or videos of their arts, sculptures or collections with associated details to showcase, sell, etc.

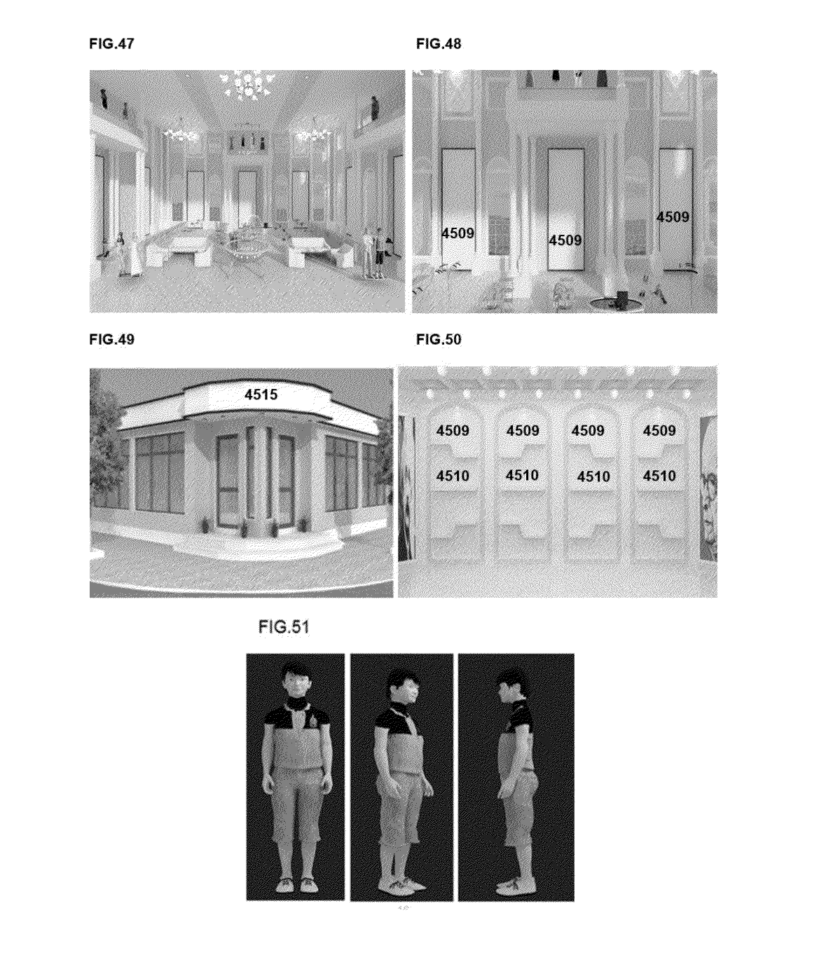

FIGS. 45, 46, 47 and 48 illustrate exemplary 3D view designs for an interactive shopping mall using marble and glass as primary materials. FIG. 45 shows the exterior view with people, a cobblestone road, a decorative lotus pond outside the entrance glass door shown opened with a water fountain and other shop interiors visible through the glass. FIG. 46 shows another outside view with compound/fence, decorative palm trees, cars, sky, etc. FIG. 47 shows empty display panels inside the shop on the marble walls next to each window for a user to keep items on. FIG. 48 shows a zoomed in view of 3 of the showcasing panels. FIGS. 47 and 48 also show other showcasing mantles, shelves, hangers on stands, etc. with outside views visible through the glass windows. FIG. 47 also shows sample 3D mannequins showcasing clothes and accessories on upper display mantles and in the front right and left, aisles with hangers on stands, glass display shelves, chandeliers hanging from the ceiling, etc. FIG. 49 shows another sample 3D shop around the corner with a sample interior view of a showroom with four showcasing panels including shelves, posters on sides, light sources, etc.

Various parameters in such sample figures from 10 to 51 could be used interchangeably, such as, but not limited to, interchanging, or using different, color themes, shapes, sizes for the showcasing panels, decorations, light sources, floor patterns, ceiling patterns, or the showcases and showrooms could be interchangeably placed inside any other shop, or made as an independent 3D showroom, or exist independently as a singular, or plurality of, shown showcasing panel(s). In yet another embodiment of the showcases and showcasing system (333), multi-dimensional designs could be used to create race tracks or any other design for any event, e.g. vehicle racing and/or other gaming events, and could be integrated with any other system, e.g. sports system (334) described later and programmed for conducting virtual sporting/gaming events. The system uses built-in programs, etc. to gather and store data inputs from such GUIs, and is integrated with the User Intelligence Engine (105) and the Auto-matchmaking and marketing engine (118).

Styles system/module (338) is yet another embodiment of the invention for the end-to-end effective event management, engagement, cross-interactivity, empowerment and optimization (108), which includes an innovative method and system to manage the processes, including but not limited to, of showcasing various styles, such as, including but not limited to, designs for clothing, trendy accessories or other things, home furnishing styles, home interior arrangement styles, made by, including but not limited to, professional fashion designers, as worn by celebrities, models, actors, interior decorators, etc. One of the many process flows of the styles system (338) comprises GUI components, including but not limited to, making a selection from, a kind of styles, e.g. classic, modern, etc., from a category, e.g. clothing, housing, accessories, automobiles, etc., from a sub-category, e.g. menswear, womenswear, kidswear, furnitures, sports cars, motorbikes, etc. The system further provides for uploading, editing, downloading objects/items/etc., sharing, uploading, downloading, entering data from address books and/or other contacts, entering, sending, receiving and/or sharing messages, sharing showrooms and/or selecting and sharing any, many or all of the showcases from any or many showrooms, etc., selecting one or more such items showcased and adding to carts, baskets or any such storage components. The styles system further includes showcasing such items on virtual multi-dimensional models, including but not limited to, human figurines, wax statues, 3D mannequins, etc. FIG. 51 shows sample embodiments of a 3D virtual human model in multiple views for front, left and right, seen in 360 degree rotation. The system uses built-in programs, algorithms, codes, etc. to gather and store data inputs from such screens, and is integrated with the User Intelligence Engine (105) and the Auto-matchmaking and marketing engine (118) described later. The system further includes GUI components, such as, including but not limited to, for decorating such showrooms with wallpapers, wall hangings or other things, providing ways of viewing showrooms and/or showcases using walkthroughs, providing multiple designs for such showcases, including but not limited to, wall papers, wall hangings, wall boards, photo frames, wall designs, revolving galleries, revolving doors, central pieces, glass mounts, showcase cut-outs in walls with glass sliders, etc. in multiple or customizable sizes and designs. Such systems could further include online closets, wardrobes, cupboards, etc. in 2D, 3D, etc. Refer FIGS. 10A, 10B, 10C, 10D to 51, described above, for various embodiments of the shops and shopping system (450), showcases and showcasing system (330), and the styles system (338).

Another embodiment of the invention for the end-to-end effective event management, engagement, cross-interactivity, empowerment and optimization (108) includes an innovative method and system for scheduling and calendars (330). The main objective of the scheduling and calendars system (330) is to not only provide a simple way to instantly store, plan events/event related tasks, but also to provide intuitive, sophisticated, aesthetically pleasing and most innovative ways to remember such events or event related activities/tasks. Another objective of this embodiment of the invention is to automate the manual processes involved in going to a printing press and getting professional calendars done for various purposes, including advertisement, distributing to customers, etc. Yet another objective is to also store personal events' information and distribute such calendars for purposes of easier recollection, greeting, gifting, etc. One of the many process flows of the scheduling and calendaring system/module (330) comprises, but is not limited to, providing GUI components, such as, providing links to perform scheduling activities around an event, checklist and calendar activities. The GUI components to perform checklist activity could further include input components, such as, but not limited to, selecting an event, adding task(s)/item(s), assigning to, e.g., names and/or user ids of the registered or guest users of the system, adding notes in relation to such tasks or assignees, assigning a start date, an end date, number of days, adding updated start date, end date, etc., adding user names of those who assign or update any such item, for purposes, such as, tracking or maintaining a history, request update(s), such as, an automated email with a request to send an update on an item, which the system then sends to the users to whom the items/tasks were assigned to, and modified as needed.

Another of the many process flows of the scheduling and calendars system/module (330) comprises, but not limited to, providing GUI components, such as, providing links to perform calendaring activities around an event, including but not limited to, selecting a design for calendar art from a plurality of design themes provided by the system, including but not limited to integrating with the events gallery system to pull any photos/videos from, and/or choosing a plain number calendar without designs and/or uploading designs/photos/videos/files from a computer/device in use, selecting from a kind of calendar, e.g. general, personal, official religious etc., adding a name to the calendar or selecting from a list of already stored calendar names with calendar information, selecting from a list of languages/dialects, for e.g. English, Hindi, Tamil, etc., selecting from a list of fonts, colors, size, and other editing functionalities, selecting from a set of numbering themes, layouts/formatting for the dates, days, months and years, e.g. a user could choose to view/edit a calendar numbering layout of only one date in one instance and/or to view/edit a calendar numbering layout of all the dates in a calendar month in one instance, and/or to view/edit a calendar numbering layout of all the dates in a calendar month and all such calendar months in an year in one instance, etc. The system further provides for GUI components, such as, but not limited to, clicking on each such date and adding, viewing, editing events to be remembered, associated tasks to be remembered, any significance to be mentioned, and/or general notes, pertinent to the date/day/month/year, reminder alerts, etc. The system further provides GUI components, to save the calendar(s), to download, to send/share/exchange with contacts, upload such contacts, order prints, with additional printing related settings, including but not limited to, layouts, print sizes, paper quality, binder kind, if any, calendar type, for e.g. desktop or wall calendars, material(s)/things to be printed on, etc., collecting shipping information, payments, if any, etc. Refer FIG. 54. The system uses built-in programs, algorithms, codes, etc. to gather and store data inputs from such screens, and is integrated with the User Intelligence Engine (105) and the Auto-matchmaking and marketing engine (118) described later.

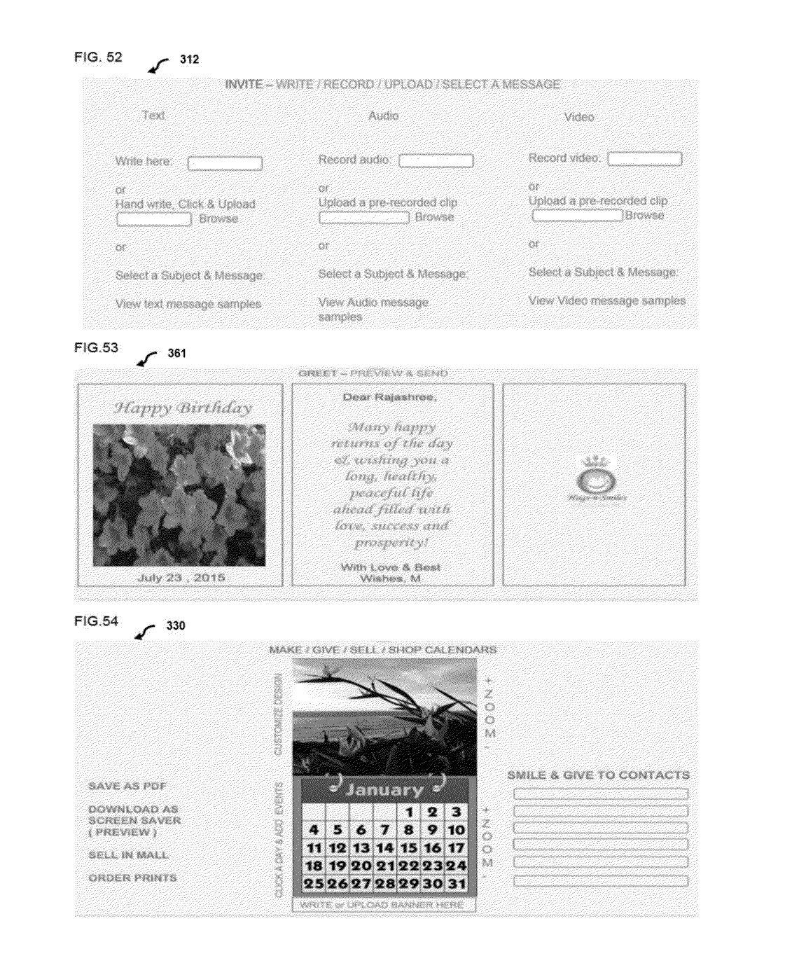

Another embodiment of the invention for the end-to-end effective event management, engagement, cross-interactivity, empowerment and optimization (108) includes an innovative method and system to extend invitations and/or greetings (312 & 351). One of the many process flows of the invitations and greetings system/module comprises, but not limited to, providing graphical user interface components, such as, providing links to perform activities to extend invitations to an event and/or sending greetings for an event. Such links could further direct the user to graphical user interface components such as screens with input components, including but not limited to, selecting an invitation/greeting category, a sub-category, a design theme, a design sub-theme, uploading user's own photos/videos or other files to be used in the invitation or greeting, entering a subject of the invitation or greeting, e.g. Happy Birthday, Baby shower invitation or Happy Anniversary greetings, the sender's information, for e.g. pre-populated email address of the user which could be edited as needed, entering the invitation and/or greetings message as a text into the provided input components using, e.g. keyboards, touchpads, stylus, fingers, or digital pens, uploading any hand written or other designs for the invitation and/or greeting(s) message(s), selecting from system provided messages, selecting fonts, colors, sizes and other editing options for such messages, adding any files as attachments if needed, recording audio/video messages with the system provided integrations with a camera or microphone in use, uploading a pre-recorded audio message or a video message or a multi-media message and selecting from, or entering, subjects to such messages, previewing all such messages, viz., text, audio, video, multi-media, etc., providing user options to select a layout for the invitation, e.g. a greeting card, a one-page view, a multi-page view and providing other customization options as needed, etc. Refer FIGS. 52 and 53. FIG. 52 illustrates an exemplary embodiment of the GUI input components for a message in text, audio, video or any combinations thereof, for an invitation and/or a greeting. FIG. 53 illustrates an exemplary embodiment of an interactive and customizable greeting card that can be sent as an e-greeting and/or printed as a paper greeting card and/or as a multi-media, audio-video-photo greeting card. The system further provides GUI components to perform activities, such as, but not limited to, save, print, send, share, forward, exchange, download, etc. of such invitations and/or greeting(s) either by the sender(s) or the recipient(s), to integrate with, e.g., greeting/invitation card(s) manufacturers, printing press, etc., and further provides GUI components for such manufacturer(s) and/or service providers to manage their accounts and interactions with the greeting(s) (351) and/or invitations system (312).

Another embodiment of the invention for the end-to-end effective event management, engagement, cross-interactivity empowerment and optimization includes an innovative method and system to send gifts (351). One of the many process flows of the gifts system/module (351) comprises, but not limited to, providing GUI components, such as, providing links, and/or input components, to perform gift giving activities such as selecting from a category of gifts, for e.g. gift cards, cash, flowers, goods or services, selecting from an occasion/event for gift, adding a gift to a greeting/invitation, selecting from a sub-category, e.g. e-gift cards, cash transfers, other forms of cash gifts, etc. selecting from a plurality of such gift delivery, payment and other options fetched from the system, integration with the search module to perform relevant search activities, integrations with manufacturer(s), third party service providers, arborists, etc. and further providing GUI components for such manufacturer(s) and/or service providers to manage their accounts and interactions with the said gift system. The system uses built-in programs to gather all the data input from such GUIs, store in the relevant data storage areas in the server system (106), and then retrieve and display such data according to the publishing requests from anywhere inside or outside the system and is integrated with the User Intelligence Engine (UIE) (105) and Auto-matchmaking and marketing engine (118).

Another embodiment of the invention for the end-to-end effective event management, engagement, cross-interactivity empowerment and optimization (108), includes an innovative method and system to set-up shops and do shopping (450). One of the many process flows of the shops and shopping system/module (450) comprises, but not limited to, providing GUI components, such as, providing links to set-up shops and perform shopping activities for entities, including but not limited to, exhibitors, sponsors, advertisers, suppliers, speakers, organizers, entertainers, sportsmen, artists, etc. Such GUI links could further direct the users to respective GUI screens with input components for setting-up shops and performing shopping activities with the respective entities. The system could further provide a plurality of designs, including but not limited to, multi-dimensional and/or 3D designs, for shops in various categories, for e.g. exhibit booths, auto shops, book house, an instruments shop, or a mall with a layout to fit multiple such shops under various categories, etc. Such shops could include system provided interactive GUI components, including but not limited to, a placeholder for shop name (4515), a door to enter (4519), outer display panels for window shopping (4520), outer surroundings (4522) e.g. decorative plants, pathways for walking, street lights, sky, pavements, roads, other buildings, structures etc. Users can further add shop name, enter through the door using navigational components to enter (4513), which could open, close, select items from window displays, or place items (4518) on window displays, add decorations, add items to cart, send items to contacts, save, bid, buy, sell, setting up of such auctions by a seller and bidding and buying by a buyer, with associated functionalities, save, print, send, share, forward, exchange, download, process payments, etc., of such shop or showcase items using system functionalities and built-in programs. The system further provides GUI components, to integrate with manufacturers, printing press, payment processing systems, IVR systems, etc., for such manufacturer(s) and/or service providers to manage their accounts and interactions with the shops and shopping system. Refer FIGS. 10A, 10B, 10C, 10 to 51, for various embodiments of the shops and shopping system, showcases and showcasing system, and the styles system. The system uses built-in programs etc. to gather and store data inputs from such screens, and is integrated with the User Intelligence Engine (105) and the Auto-matchmaking and marketing engine (118).

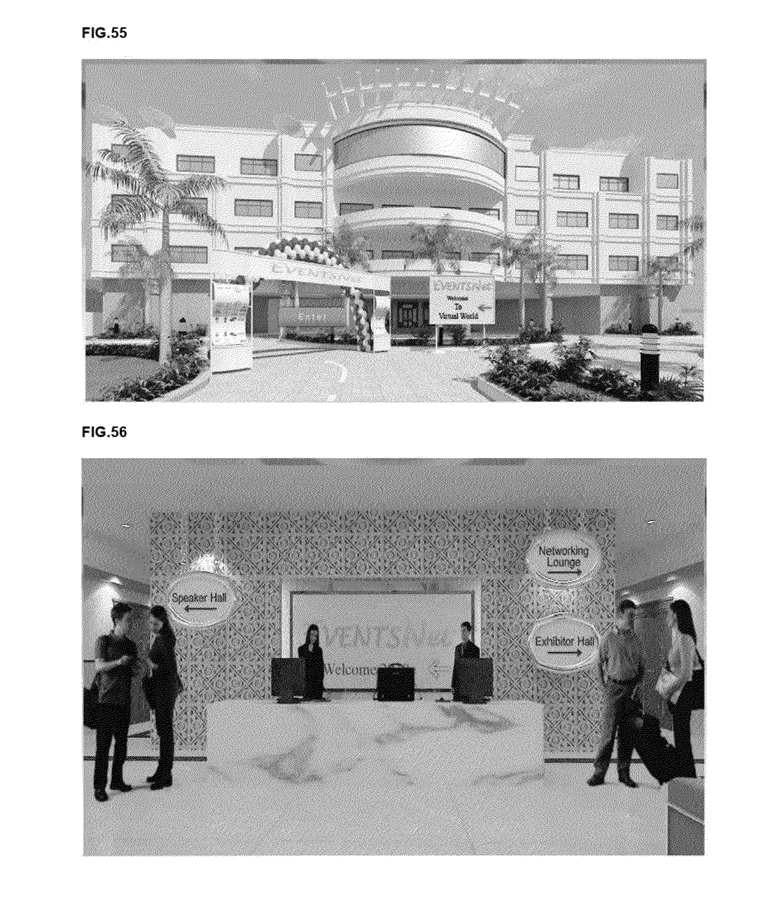

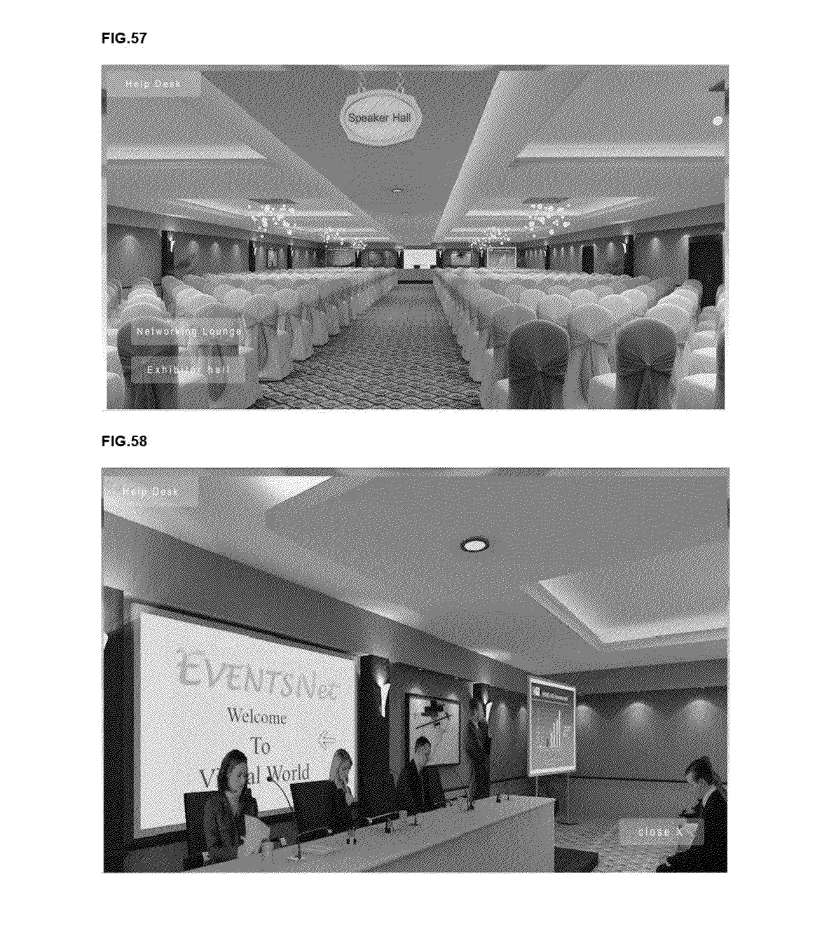

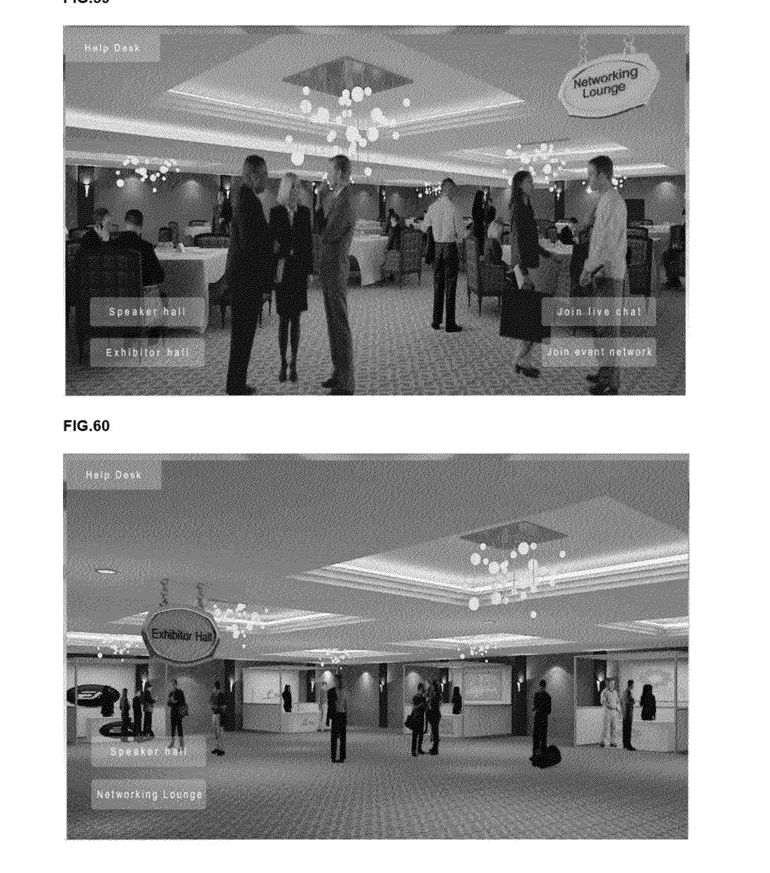

Another embodiment of the invention for the end-to-end effective event management, engagement, cross-interactivity empowerment and optimization (108), includes an innovative method and system for a virtual, immersive and interactive events environment for webinars, web conferences, or any other event that can be of virtual nature. In some embodiments of the virtual events system/module (600), one of the many process flow starts with providing GUI components, such as, providing links to the system login module that could direct the user to either register, enter as a guest or login from a homepage. The system further provides GUI components, such as links, to set-up a virtual event which could further include input components for, but not limited to, entering an event name, entering a presenter's name in case of a virtual event being set-up to give any online presentations to the event attendees, uploading presentations, attendees' information, and/or multi-media files, integrating with one or more modules/systems of the end-to-end effective event management, engagement, cross-interactivity empowerment and optimization system (108), such as, but not limited to, polls and survey modules, communications module, event interactivity module, invitations and greetings module, showcases and showcasing system, shops and shopping module, registration and ticketing module, event site building module, dashboard system, etc., integrating with the camera and/or microphone of, or connected to, the device or computer in use for live recordings, integrating with a question and answers or messages exchange panel, etc. This virtual events system could additionally include functions and features to pick and set up from a set of images or user interface designs, features and functions for setting up multiple virtual rooms including but not limited to speaker halls, registration desk, exhibitor halls, etc. Virtual events thus set-up could be previewed before going live, with additional abilities to start and stop as needed during the presentation. The viewers/users/attendees of this virtual events are further provided with user interface components to record a session/a virtual event in progress and/or download a past session/a past virtual event. Refer FIG. 55 to 60 for various sample embodiments of the virtual events system. FIG. 55 shows a sample exterior view of a 3D conference hall selected by a virtual event organizing user with an interactive button to click and enter through the entrance arch to FIG. 56 showing a sample 3D registration desk, with signboards to click and enter either of speaker hall, networking lounge, exhibitor hall or click and pick the event guide and kit kept at the center of the 3D marble desk. FIG. 57 shows a sample 3D virtual speaker hall with links on the left to navigate to either of help desk, networking lounge, exhibitor hall or to click in the center of the hall on the presentation screen and zoom into the speakers section shown in FIG. 59 and be able to listen and/or view any presentations. FIG. 58 shows a sample 3D networking lounge showing people interacting with each other and navigational components in the bottom left and right sides to click and get into the speaker hall, exhibitor hall, join a live chat, get into the interactivity area or a help desk on the top left. FIG. 60 shows a sample 3D exhibitors hall showing 3D booths each of which could be clicked to zoom into a 3D view of such booths, such as, in FIG. 17, which shows electronic speakers placed on the left and right side of the booth for audio effects, a screen inside the booth for presentations, etc. The system uses built-in programs, algorithms, codes, etc. to gather and store data inputs from such screens, and is integrated with the User Intelligence Engine (105) and the Auto-matchmaking and marketing engine (118) described later.

Another embodiment of the invention for the end-to-end effective event management, engagement, cross-interactivity empowerment and optimization includes an innovative method and system for ubiquitous and/or hybrid events (328). The word ubiquitous here refers to extending an event beyond the physical realms of time and space and making those available globally in such a way that attendees from different parts of the world can attend such events through this innovative system from the comfort of their home, office, island or anywhere. The system further extends such physical events to include other entities such as exhibitors, sponsors, advertisers, etc. to exhibit, advertise and/or sponsor without having a physical presence in the venue, using novel methods, including, but not limited to, integrations with any, many or all of, showcases and showcasing system, shops and shopping system, advertising system, and/or communications system(s) as described later. This system provides graphical user interface components, including but not limited to, links with GUI screens comprising input components, for a user, for e.g. an event organizer, such as, but not limited to, setting-up such ubiquitous and/or hybrid events, uploading the attendees data either through this system or by integrations with the registration and ticketing modules, collecting any fees or other information associated with such ubiquitous attendance, and/or by integrations with the event interactivity system described above, providing real time audio video streaming of the event including any sub-events, panel discussions, as may be needed, with or without further integrations with the communications module as described in detail later, providing real time assistance to any such organizer or user with such set-ups, providing virtual question and answer rooms where the questions from a remote attendee could be asked to a speaker during live Q&A sessions happening in the physical event. The system further allows for moderators to be assigned for moderating such Q&A sessions, with additional ways to queue and filter the questions. The system further allows for real-time video streaming of such remote participants in the physical venue for the speakers or others to see from whom the questions are coming from. This could further involve, providing GUI components such as links, e.g. U attendees, U video, U Q&As, U exhibitors, U speakers, U sponsors, U suppliers, U shops, etc. inside the event interactivity module/system (318) where all such ubiquitous participant information can be made available for the physical or virtual event attendees to interact with such hybrid and ubiquitous participants, and vice-versa. The system uses built-in programs, etc. to gather and store data inputs from such screens, and is integrated with the User Intelligence Engine (105) and the Auto-matchmaking and marketing engine (118).

Another embodiment of the invention for the end-to-end effective event management, engagement, cross-interactivity empowerment and optimization (108) includes an innovative method and system for a communications system (342). This system could further include, but not limited to, instant messenger system/module (343, 344, 347) and/or chat (345) applications. This embodiment of the invention further includes built in communication functions and capabilities including but not limited to sending and receiving invitations, creating and exchanging audio, video or text chats, forming groups and/or networks of contacts. This could include invitations sent by organizers and/or invitations sent by users amongst each other or to outsiders. Larger the audience, more difficult it gets to manage critical announcements during the event, assembling and reminding attendees about many activities including but not limited to any games or fun activities being conducted by the organizers or sponsors, any networking receptions being hosted by the organizers or sponsors, any fund raising or entertainment shows being held and communicating any last minute changes that may have happened. Most of the organizers have been using traditional approaches of contacting or notifying via emails, phones or making public announcements using any of the broadcasting options in a venue. The biggest issue with such methods is that the attendees may already be pre-occupied with several panel discussions, client meetings, having their meals or any of the many activities they would be doing and are generally scattered in various locations in and around the venue halls and such announcements may not be heard or read by them. While some location services in the past have tried to keep track of the attendees, many attendees prefer to remain private and not be tracked by such location trackers and many organizers have preferred not to invade such privacy boundaries of their attendees. The current embodiment of the invention allows for such non-intrusive communications while also ensuring that all are kept informed about any changes or announcements before, during or after the event. Such communication capabilities further include tracking arrival and departure information of attendees. Such communication capabilities further include a personal digital assistant, for example, in the form of an animated character to act as an event assistant to each of the attendees. User will have the choice to either turn the assistant feature on or off. The event assistant will assist all attendees with customizable functions including but not limited to reminders, announcements, searching, concierge services and other functions. Each of the communication options could be organized by a communication type and users could further use any, many or all of the built-in or any third party integrated functions. Such programs, functions and features can further be set-up from within the system or as a standalone with additional capabilities including but not limited to customizing, editing, auditing, querying and reporting. This could additionally include any or many of storage, retrieval, embedding, backend event administration and management including collaboration abilities among users with customizable permissions settings including view, edit, save, delete, and display of such data in multiple placeholders across any system including transporting such data via emails to users or to and from third party servers.

One of the many process flows of the communications system/module comprises, but not limited to, graphical user interface components, such as, providing links to the system login module (301) that could direct the user to either register, enter as a guest, or login from a homepage. The system further provides user interface components, such as links, to set-up the communications system, which further directs the users to other user interface components, such as screens, which could show all the online users by default, input components for entering messages, attaching files, sending, receiving and forwarding such messages, etc. Such users could include, event attendees, exhibitors, sponsors, advertisers, speakers, entertainers, and/or members, and/or all those associated with an event, an organization, a group of one or more people, or otherwise. The communications system (342) can be further made available in mobile and/or wearable devices in such a way that a user could choose to synchronize all of his/her devices/computers to be able to use any part of the communications system, for e.g. the messenger system (343, 344, 347). Users could further opt for using such an instant messenger, for e.g. for receiving/sending messages, in either one or more such devices and turn on or off other devices as and when needed. This communications system, including but not limited to the messenger system, could be integrated with any, multiple or all modules/systems (shown in FIG. 3.) of the end-to-end effective event management, engagement, cross-interactivity empowerment and optimization system. The system uses built-in programs, algorithms, codes, etc. to gather and store data inputs from such screens, and is integrated with the User Intelligence Engine (105) and the Auto-matchmaking and marketing engine (118) described later.

Another embodiment of the invention for the end-to-end effective event management, engagement, cross-interactivity empowerment and optimization includes an innovative method and system for suppliers systems (361). One of the many process flows of the suppliers system/module comprises, but not limited to, providing graphical user interface components, such as, providing links to the system login module that could direct the user to either register, enter as a guest, or login from a homepage. The system further provides user interface components, such as links, to set-up the suppliers system, including but not limited to, input components for any, many or all suppliers associated with an event to have an account, within which the system could further provide for suppliers information, such as, but not limited to, materials, goods and/or services procurement information, billing, invoicing, etc. This suppliers system, could be integrated with any, multiple or all modules/systems (shown in FIG. 3.) of the end-to-end effective event management, engagement, cross-interactivity empowerment and optimization system (108). For e.g., the event interactivity system (318) could show a link integrated with the suppliers module where all the suppliers' may be listed with their respective information and allowed to do interactivity with other people associated with an event or an organization as explained in the event interactivity (318) and member interactivity (319) systems. In another process flow this suppliers' system could be integrated with the advertising system explained in detail later. The suppliers system could further include either separate or integrated systems/modules for venue providers, stage lighting, electrical fittings and other venue related goods or service providers, vehicle and transportation providers, travel and accommodation providers, etc. as shown in FIG. 5., with respective information. The system uses built-in programs, algorithms, codes, etc. to gather and store data inputs from such screens, and is integrated with the User Intelligence Engine (105) and the Auto-matchmaking and marketing engine (118) described later.

Another embodiment of the invention for the end-to-end effective event management, engagement, cross-interactivity empowerment and optimization (108) includes an innovative method and system for an advertising system (371). The main objective of this advertising system is to meet the demand and supply requirements of the events ecosystem by building an advertising network comprising of, but not limited to, suppliers with goods and services to offer, exhibitors who generally exhibit their products in various events worldwide, organizers who constantly engage in marketing and promotional activities of their events, consumers who buy such goods/products and services who may be attending various such events either physically or remotely, speakers, entertainers, artists, sportsmen, etc. who may be invited in such events as guests, or who may themselves be hosting events such as concerts, sporting events, fundraisers, etc., using innovative methods and systems described later as embodiments of the present invention, etc. This innovative advertising system discovers advertising opportunities in any, many or all of the modules/systems of the end-to-end effective event management, engagement, cross-interactivity empowerment and optimization system (108), identifies advertisers and matches them with suitable advertising space and audience to boost return on investments.

One of the many process flows of the advertising system/module (371) comprises, but not limited to, providing graphical user interface components, such as, providing links to the system login module (301) that could direct the user to either register, enter as a guest, or login from a homepage. The system further provides user interface components, such as links, to set-up the advertising system, including but not limited to, input components for any, many or all potential advertisers associated with an event to have an account, within which the system could further provide for advertisers' information, such as, but not limited to, materials, goods and/or services they sell/provide, billing, invoicing for any advertising activities they may engage in, industry, organization, events they may be associated with, or have potential interests in, information of attendees, including but not limited to, demographics, system usage patterns, buying patterns, history, geographical locations, etc. The system uses built-in programs, algorithms, codes, etc. to gather and store data inputs from such screens, and is integrated with the User Intelligence Engine (105) and the Auto-matchmaking and marketing engine (118) to offer targeted advertisements optimized for maximum return on investments. This advertisers system (371), could be integrated with any, multiple or all modules (FIG. 3.) of the end-to-end effective event management, engagement, cross-interactivity empowerment and optimization system (108). e.g., the event interactivity system (318) could show advertisements using the advertising system.

Another embodiment of the invention for the end-to-end effective event management, engagement, cross-interactivity empowerment and optimization (108) includes an innovative method and system for an auto matchmaking and marketing system (118). The main objective of this embodiment of the invention is to effectively match-make the various entities associated with an event, or match-make them with other entities of other events, automatically in ways that such entities would not have otherwise realized the potential benefits of such cross interactivity, or might have missed out on by not taking the initiatives to connect themselves. One of the many process flows of this auto matchmaking system (118) includes, but is not limited to, the system using its built-in programs, algorithms, codes, etc. to gather all the data inputs from several modules as shown in FIG. 3, and further fetching the user intelligence information stored by the User Intelligence Engine, creating automatic suggestions, and sending such suggestions to the various entities associated with one or more events, as may be requested. For e.g. an entrepreneur seeking investments could be given multiple suggestions about the potential investors who may be in the events ecosystem, whom otherwise the entrepreneur may not have approached or known about. The system further provides user interface components, including but not limited to, screens with input components for the users to search for such auto-matches received, which could further include links to respective data, which could further include user interface components to store, edit and/or forward such information, etc. This system further provides GUI components to help event organizers receive and retrieve an automatic list with plurality of records with specific information for marketing their events, such as, but not limited to, a list of potential attendees, exhibitors, sponsors, advertisers, entertainers, sportsmen, speakers, etc. who could participate in their event(s), specifically targeted and short-listed based on several parameters, such as, but not limited to, an understanding of their needs, past events data optimized to predict future event needs, industry trends, socio economic factors, etc. Such data could be further customized.

Another embodiment of the invention for the end-to-end effective event management, engagement, cross-interactivity empowerment and optimization includes an innovative method and system for the User Intelligence Engine (UIE) (108). One of the process flows of this system includes, but is not limited to, the system using its built-in programs, algorithms, codes, etc. to gather all the data inputs from several systems/modules as shown in FIG. 3. The UIE (108) parses such data, starts recognizing usage patterns, such as the data entered and/or modified via the input components in the system/module, any exchange of information, history and other attributes such as personal preferences, etc., optimizes data, and makes information available for current or future use. Such future use could include providing intelligence on such users to make future events more productive, to better organize with prior knowledge about the target audience and boost the return on investments for all entities associated with the event including organizer, attendees, sponsors, advertisers, suppliers, venue providers, entertainers, speakers, etc. This system further provides GUI components so that a user, such as an event organizer or any other user of the system with relevant permissions, is able to understand several parameters, including but not limited to, the various event(s) held and attended, exhibits kept, advertisements given, materials supplied, meetings held, polls/surveys done, members added, etc. The UIE again uses built-in programs, algorithms, codes, etc. to gather all the data input from such GUI screens, store in the relevant data storage areas in the server system, and then retrieve and display such data according to the publishing requests from anywhere inside or outside the system. This UIE system, could be integrated with any, multiple or all modules/systems (shown in FIG. 3.) of the end-to-end effective event management, engagement, cross-interactivity empowerment and optimization system (108). e.g., the UIE could directly feed data into the management analytics and reporting module (358) so that such information could be effectively processed, searched for and provided as reports, as and when needed.

Another embodiment of the invention for the end-to-end effective event management, engagement, cross-interactivity empowerment and optimization includes an innovative method and system for a simulator system (355). The main objective of the simulator system is to offer predictive analytics information to help event organizers, or any other user with relevant permissions, to perform simulation activities, including but not limited to, the actual event day happenings, hospitality arrangements, for e.g. travel, hotels, food consumption analysis, number of customer meetings that could be held, etc. One of the process flows of this simulator system includes, but is not limited to, the system using its built-in programs, algorithms, codes, etc. to gather all the data inputs from several modules as shown in FIG. 3. The system further provides user interface components, including but not limited to, screens with input components for the users to enter pertinent data, for e.g. an event organizer could select a venue and input the number of expected attendees or exhibitors using the simulator system, and the system could generate an interactive map, including 3D/audio-video integrations as needed, to help the user understand how to plan the various exhibits, speaker sessions, set-up customer meetings, arrange for hospitality, receptions, entertainment, etc. This system could further provide pre-event and post-event activities related simulations and user interface components to store, edit and/or forward such information, etc. The system uses built-in programs, algorithms, codes, etc. to gather and store data inputs from such screens, and is integrated with the User Intelligence Engine (105) and the Auto-matchmaking and marketing engine (118) described later. This simulator system, could be integrated with any, multiple or all modules/systems (shown in FIG. 3.) of the end-to-end effective event management, engagement, cross-interactivity empowerment and optimization system (108)

Another embodiment of the invention for the end-to-end effective event management, engagement, cross-interactivity empowerment and optimization includes an innovative method and system for a dashboard system (349). This embodiment of the invention includes, but is not limited to, a live real-time dashboard for the event organizer to track and display all the activities happening, pre-event, during the event and after the event, with other analytics and reports as required. Pre-event activities could include any, many or all listed under the pre-event module/system above, referred to in FIGS. 3 & 4. Activities during the event could include communicating with one, many or all of the participants using built in communication functions such as invitations, notes, video, audio or text messages and/or everything stated above under the event interactivity, registration and ticketing activities, and under during events system/module, Virtual or Hybrid Ubiquitous events, each explained below. Live dashboard is specifically meant to address several issues prevalent in larger events with thousands of attendees besides being useful to smaller events with less than a hundred or hundreds of attendees, which specifically include communication issues, besides many other. Live dashboard provides interactive user interface components, including but not limited to, all of the pre-event, during, post-event activities, member interactivity, and/or event interactivity statistics and charts per criteria that can be set-up by the users. Live Dashboard data for during event activities could include, but are not limited to, real time ticket sales, real time polls and surveys conducted, tracking, recording, storing and displaying scores from games played, prizes, trophies and cups won, player profiles and statistics, recording, storing and displaying of artist details, music, movies or any other entertainment details including, but not limited to, any promotions, coupons and/or discounts offered, storing and charting of such results and tracking and analyzing any, many or all the data obtained from the embodiments above and/or modules shown in FIG. 3, in real time, as used by the attendees. E.g. the dashboard could display to an organizer the number of communication messages being exchanged between attendees by communication type, number of meetings set up between sponsors, exhibitors or attendees, any product sales, demos happening, arrival and departure tracking, or food, stay or travel tracking, collection of all the event news, PR, real time press coverage, and any other event related article(s) published anywhere in the globe. Such data could further be analyzed and presented in the form of queries and various reports, as described under management analytics and reports (358) later.

In another embodiment of the invention for the During-event activities system (313), all the during-event processes for both the organizer and the attendees including, but not limited to, exhibitors, sponsors, speakers, entertainers, and other guests, are automated in a novel way. Depending on the size of the event, the processes for an event organizer comprising, but not limited to, making announcements, conducting polls/surveys, sending event updates and interacting with their attendees, exhibitors, sponsors and other guests and monitoring their hospitality arrangements, could get overwhelming. In order to accomplish such tasks, many event organizers have to employ several personnel with huge monitory investments. Some programs available in the market or other inventions referred to in the prior art neither cater to the specific needs of different sizes of events around the world nor are comprehensive enough to cover every event process in a streamlined and integrated manner. In this embodiment of the invention as described below, all such during-event processes are automated and presented in a streamlined, intuitive and novel way as part of the end-to-end effective event management, engagement, cross-interactivity empowerment and optimization solution, thereby saving substantial man hours and productivity, making the event organizers and everyone associated with the event extremely happy. One of many process flows of the during-event activities, starts with an event organizer registering into the system using graphical user interface (GUI) screen for registration provided by the system. The user then clicks on a link provided by the system to perform during-event activities. The process could also start with an already logged in user, for e.g. an event organizer, directly clicking on the link provided to perform during event activities. The user is then directed to a screen comprising links to perform activities such as, but not limited to, Announcements, Polls, Event updates and interactivity. The interactivity link further directs the user to the Event interactivity system (318).

Announcements system/module (314) further directs the user to the GUI screens provided by the system, comprising links for setting-up announcements, with input components for recording audio, text, and/or video announcements, viewing, hearing, watching such announcements and being able to edit. This system provides a built-in code that integrates a microphone or a camera either connected to, or built in, the computer or any device in use and allows for recording any, many or all of audio, audio-video or video announcements into the system. This system also provides input components for entering and saving text announcements. Once recorded, such announcements can be saved with a unique name for each such record, reviewed, edited, canceled or sent to users.

Polls system/module (315, 354) directs the user to the GUI screens provided by the system, comprising links for setting-up a poll, viewing or editing the poll set-up and to view the results of the poll after sending to the users. The Poll set-up function further includes input components, not limited to, for selecting an event to conduct polls for, selecting a poll kind, e.g. horizontal bars, vertical bars, pie chart, trend lines, etc., poll name, any questions or statements with answer choices, poll timing for e.g. whether to be conducted during middle of the event, at start of the event or at end of the event or, pre-event, and selecting a kind of answer choices preferred, e.g. Yes/No, Multiple choices, User entered answer, etc. This system further provides user interface images for Save, preview, send and cancel, using which the user can either simply save the poll for viewing and editing later, preview the poll and send to users, or cancel and re-enter the poll data, respectively. The system uses built-in programs etc. to gather and store data inputs from such screens, and is integrated with the above described User Intelligence Engine (105) and Auto-matchmaking engine (118).

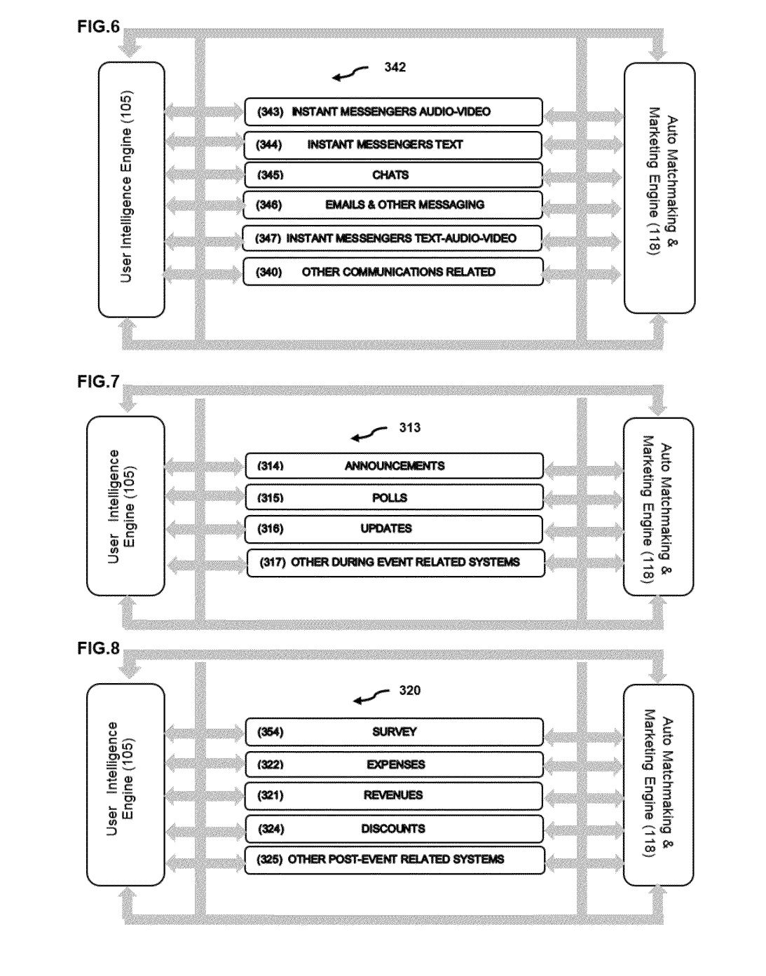

Event Updates system/module (316) directs the user to GUI screens provided by the system, comprising links and input components for adding and sending any event related updates, including but not limited to, event related news and press articles, and viewing or editing those as necessary. The modules described above such as the announcements module, event updates module, polls module could also be integrated with the Pre-event or Post-event activities modules as necessary. The system uses built-in programs, algorithms, codes, etc. to gather all the data input from such user interface screens from each of the announcements, poll, event updates modules described above, store in the relevant data storage areas in the server system, and then retrieve and display such data according to the publishing requests from anywhere inside or outside the system, and is integrated with the User Intelligence Engine (105) and the Auto-matchmaking and marketing engine (118) described above. For e.g. Announcements system could be a part of the communications module/system as shown in FIG. 6, and could be integrated as a part of the communications system in any of the many modules, and/or could be independently used/integrated as an announcements system. Polls system could further be integrated as a part of the during-event activities system, post-event activities system, and/or the events interactivity system.

In another embodiment of the invention for post-event activities system (313), all the post event processes for both the organizer and the attendees including, but not limited to, exhibitors, sponsors, speakers, entertainers, and other guests, are automated in a novel way. Depending on the size of the event, the processes for an event organizer comprising, but not limited to, conducting post event surveys, offering discounts for upcoming/future events, recording all the expenses incurred in the event, recording all the payments made and revenues received and generating event analytics and reports, could get overwhelming. In order to accomplish such tasks, many event organizers have to employ several personnel with huge monitory investments. Some programs available in the market or other inventions referred to in the prior art neither cater to the specific needs of different sizes of events around the world nor are comprehensive enough to cover every event process in a streamlined and integrated manner. In this embodiment of the invention as described below, all such post event processes are automated and presented in a streamlined, intuitive and novel way as part of the end-to-end effective event management, engagement, cross-interactivity empowerment and optimization solution, thereby saving substantial man hours and productivity, making the event organizers and everyone extremely happy.

The process starts with an event organizer registering into the post-event activities system (313) using a GUI screen for registration provided by the system. The user then clicks on a link provided by the system to perform post event activities. The process could also start with an already logged in user, for e.g. an event organizer, directly clicking on the link provided to perform post event activities. The user is then directed to user interface components, such as, screens, comprising links to perform activities such as, but not limited to, Survey, Discounts, Expenses, Payments, Revenues and Reports.

The survey system (354) could include, but not limited to, interactive user interface components, to set-up a survey, which could further include, but not limited to, selecting an event or events, giving a name to the survey, setting up survey questions and answer choices, selecting a scale, for e.g. 1 to 3, 1 to 5, 1 to 10, etc. and/or selecting from a plurality of grades to select from excellent, good, poor, extremely satisfied, satisfied, unsatisfied, etc., a preview of the survey thus set-up and options to send such surveys either to all the attendees of the event(s) selected, or specific addresses that could be selected or added via further input components to do so. Such surveys could also be previewed and saved, to be viewed and/or edited later and sent to the recipients. The recipients then submit the survey, and the system then stores such results under a separate link with interactive user interface components for viewing such results. The system further provides graphical and/or text results such as, but not limited to, charts trends, statistics and/or reports from such surveys, for use by the event organizer towards survey/feedback analysis.

The Expenses recording system (322), provides interactive user interface components, not limited to, input components for selecting an event or events, selecting from a plurality of categories listed, selecting from a plurality of items available under each such category, entering the budget allocated or the system pre-populating the budget allocated, entering the actual expenses incurred or the system pre-populating the expenses incurred, the system then calculating the difference between the budgeted amount and the expense and prompts the user to either of select or enter a reason for the difference, viewing and/or editing data.

The Revenues recording system (321), provides interactive user interface components, not limited to, input components for selecting an event or events, selecting from a plurality of categories listed, selecting from a plurality of items available under each such category, entering the revenues earned or the system pre-populating the revenues generated per each such item under a category or sub-category, viewing and/or editing data.

The discounts system (324), and the reports system for post event, could further be integrated with the referral and rewards system (357) and management analytics and reports system (358) respectively, which are explained in detail below, and discounts could be sent to the users, for e.g., to boost participation in upcoming events.

The modules described above, such as, the surveys module, expenses module, discounts module, revenues system and reporting module could also be integrated with the Pre-event or During-event activities modules as necessary. The system uses built-in programs, etc. to gather all data inputs from GUI screens from each of the announcements, poll, event updates modules/systems described above, store in the relevant data storage areas in the server system, and then retrieve and display such data according to the publishing requests from anywhere inside or outside the system, and is integrated with the User Intelligence Engine (105) and the Auto-matchmaking and marketing engine (118).

Another embodiment of the invention for the end-to-end effective event management, engagement, cross-interactivity empowerment and optimization includes an innovative method and system for a referral and rewards system (357). The main objective of such a referral and rewards system is to spread the awareness globally, grow the customer base, promote loyalty programs and increase usage, while rewarding users along the way with innovative methods and systems for rewards.

One of the many process flows of this referral and rewards system (357) includes, but is not limited to, this system using its built-in programs, algorithms, codes, etc. to gather information from several modules as shown in FIG. 3., such as, but not limited to, the time spent by a user in any module, number of interactions, meetings held, referrals sent, etc. This system further provides user interface components, including but not limited to, screens with input components to perform the referral and rewards activities, such as, but not limited to, sending referrals to other contacts with any of the marketing data, promotional incentives and/or rewards information, tracking the rewards accumulation, either in the form of points, or some score keeping mechanisms, redeeming such points or scores earned in any of many ways, including but not limited to, earning discounts on products or services related to the end-to-end effective event management, engagement, cross-interactivity empowerment and optimization system, and/or its partners, and/or third-party manufacturer(s), goods and service providers. This system could further include user interface components to store, edit and/or forward such information, etc. The system again uses built-in programs, algorithms, codes, etc. to gather all the data input from such user interface screens, store in the relevant data storage areas in the server system, and then retrieve and display such data according to the publishing requests from anywhere inside or outside the system, and is integrated with the User Intelligence Engine (105) and the Auto-matchmaking and marketing engine (118) described above. This referral and rewards system, could be integrated with any, multiple or all modules/systems (shown in FIG. 3.) of the end-to-end effective event management, engagement, cross-interactivity empowerment and optimization system (108). For e.g. The ticketing and registration (311) module could be integrated with this system in such a ways that a so called magic code can be transmitted using NFC, Bluetooth or spoken out loud, sent as text, automated audio, video or audio-video output, using the programs, codes, algorithms for discount generation in the referrals and rewards system. This distributed generation of coupon code could further be based on a set of rules defined by the event management system, including but not limited to, those defined by the user intelligence system, or auto-matchmaking and marketing system through the relevant communication channels. The discount program having a set of rules could be provided from the event management system to a coupon generating subsystem via a communication channel. The coupon generating subsystem could further be authorized to independently generate a coupon code without requiring communication between such coupon management subsystem and discount programs.

Another embodiment of the invention for the end-to-end effective event management, engagement, cross-interactivity empowerment and optimization includes an innovative method and system for management analytics and reports system (358). One of the many process flows of this management and reports system includes, but is not limited to, the system using its built-in programs, algorithms, codes, etc. to gather information from several modules as shown in FIG. 3., and provide analytics information and reports to the users with relevant permissions. This system further provides user interface components, including but not limited to, screens with input components to perform the analytics and reporting activities on, but not limited to, budget, event, value, attendance, sales, sponsorships, exhibitors, ticket and registration, marketing, hospitality, speakers, ubiquitous/hybrid events, suppliers, virtual events, advertisements, expenses, etc. This system further provides input components to run the queries, set selection criteria, selecting output layouts of the reports such as, but not limited to, data or charts, etc. This system could further include user interface components to store, edit, download, export, import, and/or forward such information, etc. The system uses built-in programs, algorithms, codes, etc. to gather and store data inputs from such screens, and is integrated with the User Intelligence Engine (105) and the Auto-matchmaking and marketing engine (118).

Another embodiment of the invention for the end-to-end effective event management, engagement, cross-interactivity empowerment and optimization includes an innovative method and system for a support system (370). One of the many process flows of this support system includes, but is not limited to, the system using its built-in programs, algorithms, codes, etc. to gather information from several modules as shown in FIG. 3., and provide support services as needed. Such support services, could further include, but not limited to, involving support personnel as needed to help via communication mediums such as email, phone, chat, and/or using a support system. The support system could further provide user interface components, including but not limited to, screens with input components to perform the support activities on, but not limited to, pre-event, during-event, post-event activities, event site set-up, value emphasis and extraction, increasing attendance, sales, sponsorships, exhibitors, ticket and registration, marketing, hospitality, speakers, ubiquitous/hybrid events, value-addition for suppliers, virtual events, advertisements, tracking expenses, etc. This system further provides input components that include, but are not limited, to create support requests to help with logging issues, select type of support requested, queue such requests, assign support personnel to such requests, attend to such requests, track progress of such requests, interactive components for the users requesting such support services with support personnel attending to such requests, closing such requests when issues get resolved or requests are attended to, create and send surveys about such support services or support personnel, generate and track satisfaction index using built-in methods and mechanisms. This system could further include user interface components to store, view, edit, download, export, import, and/or forward such information, etc. This support system (370) could further include a method and system for generation of interactive avatar which could further include customization interfaces where a user of the system could select from a list of customization options, that could include but not limited to, several animation characters, avatars, interactive multi-dimensional, 2D, 3D characters exclusively designed for use with the support system, audio voices, video visuals, audio-video support, text support, etc. Such animation characters and/or avatars could further be customized and to cater to the global industry, for various embodiments of the system, such as but limited to, those provided to global events industry both business and/or personal, concert industry, sporting events industry, movies industry, theme parks industry, enterprises, consumers worldwide, etc. by country, language, personal preferences, etc. This system could further provide methods for such avatar and/or animation characters to evolve or alter appearance, animation or other audio or visual characteristics based on several inputs. This system uses built-in programs, algorithms, codes, etc. to gather and store data inputs from such screens, and is integrated with the User Intelligence Engine (105) and the Auto-matchmaking and marketing engine (118).

Another embodiment of the invention for the end-to-end effective event management, engagement, cross-interactivity empowerment and optimization includes an innovative method and system called rocks system (336), which is primarily for artists, such as, including but not limited to, singers, song writers, poets, painters, collectors, etc., their fans, their event organizers, the attendees of such events and others associated with such an event, for e.g. advertisers, sponsors, exhibitors, speakers, master of ceremonies, entertainers and guests. One of the many process flows of this rocks system/module (336) includes, but is not limited to, the system using its built-in programs, algorithms, codes, etc. to combine, or use independently, any, many or all of the modules/systems as shown in FIG. 3 and described in all of the preceding paragraphs above, with any customizations and feature additions as many be required. For e.g. the member interactivity module could be customized to cater to the needs of the artists more specifically, which could further include interactivity amongst the artists within a formed group, or belonging to a band, interactivity amongst artists of multiple groups or belonging to multiple bands. In one such embodiments, the members interactivity system could also be referred to as artists interactivity module/system and could include user interface components to perform artists interactivity activities, such as, but not limited to, those related to verses and compositions in the making process, already made or storing and/or viewing collections, further adding, storing or viewing any such collections as specific references, or any other use. The user interface components for such verses and compositions could further include, input components, not limited to, for adding, viewing and editing verses, lyrics, or any write-ups and/or compositions, such input components further comprising, but not limited to, providing an html editor for text editing purposes of changing colors, fonts, etc., providing touch sensitive interfaces for writing, editing, drawing, recording with touchpads, digital stylus, fingers, etc. for browsing, selecting and uploading a file from a device or computer in use, giving a name(s) to the verse(s) thus drafted or uploaded, adding related notes, providing input components to upload, or for recording of, audio, and/or video, and/or audio/video files, further providing user interface components such as input buttons to click and save as draft or submit when finalized, user interface components to view, edit or share such drafts and/or finalized verses and/or compositions with other band members of their group or other group(s) as may be required, and/or uploading and displaying related advertisements using advertising modules if necessary. In order to address the needs of artists and those who love to interact with the artists, the event interactivity system (318) and/or any other modules/systems as shown in FIG. 3, could be further customized as may be needed to promote interactivity between artists and those attending their events, such as, concerts, fundraising events, auction events, or simply having fan clubs, etc. besides providing everything mentioned under event interactivity system (318) and the end-to-end event effective event management, engagement, cross-interactivity empowerment and optimization system (108) as described in any, many or all of the preceding paragraphs above. For e.g. the showcases and showcasing module (333) in combination with shops and shopping modules (450) could help such artists to showcase and/or sell, auction their products or services such as merchandise, collectibles, audio, video, etc. and use of the rewards and referral system could help offer incentives.

Some embodiments of the end-to-end effective events management, engagement, cross-interactivity empowerment and optimization system (108) could also be referred to as effective concerts management, engagement, cross-interactivity empowerment and optimization module/system and could include specific customizations catered to the global concerts industry, including but not limited to, by country, by language, by movie genre, etc.

In another such embodiments, the end-to-end effective events management, engagement, cross-interactivity empowerment and optimization system (108) could also be referred to as effective artists management, engagement, cross-interactivity empowerment and optimization module/system and could include specific customizations catered to the global artists industry, including but not limited to, by country, by language, by artists' kind, etc. The system uses built-in programs, algorithms, codes, etc. to gather and store data inputs from such screens, and is integrated with the User Intelligence Engine (105) and the Auto-matchmaking and marketing engine (118) described above. For e.g. the pre-event, during-event and post-event could be customized for pre-concerts, during concert(s) or post-concert(s) activities, and/or the events site building system, the ticketing and registration system, the invitations, greetings, gifting, schedule and calendar, showcases and showcasing, gallery, shops and shopping systems, referral and rewards system, support systems could each be customized, used in any, many or all of the embodiments of the Rocks system (336) for related purposes.

Another embodiment of the invention for the end-to-end effective event management, engagement, cross-interactivity empowerment and optimization includes an innovative method and system called sports system (334), which is primarily for sportsmen/women, such as, including but not limited to, cricketers, basketball player, baseball player, skiers, marathon runners, etc., their fans, their event organizers, the attendees of such events and all entities associated with such an event, for e.g. advertisers, sponsors, exhibitors, speakers, master of ceremonies, other entertainers and guests. One of the many process flows of this sports system/module (334) includes, but is not limited to, the system using its built-in programs, algorithms, codes, etc. to combine, or use independently, any, many or all of the modules/systems as shown in FIG. 3 and described in all of the preceding paragraphs above, with any customizations and feature additions as may be required. For e.g. the member interactivity module (319) could be customized to cater to the needs of the sportsmen more specifically, which could further include interactivity amongst the sportsmen/women or their associates within a formed group, or belonging to a franchise, interactivity amongst sportsmen/women of multiple groups or belonging to multiple franchises or groups of one or more members.

In some embodiments, the members interactivity system (319) could also be referred to as sport-stars interactivity module/system and could include user interface components to perform sport-stars' interactivity activities, such as, but not limited to, those related to game plans in the making process, already made or storing and/or viewing collections, further adding, storing or viewing any such collections as specific references, or any other use. The user interface components for such game plans, moves, playing strategies or such collections could further include, input components, not limited to, for adding, viewing and editing game plans, strategies or any write-ups and/or collections, such input components further comprising, but not limited to, providing an html editor for text editing purposes of changing colors, fonts, etc., providing touch sensitive interfaces for writing, editing, drawing, recording with touchpads, digital stylus, fingers, etc. for browsing, selecting and uploading a file from a device or computer in use, giving a name(s) to the game plan(s) or strategies thus drafted or uploaded, adding related notes, providing input components to upload, or for recording of, audio, and/or video, and/or audio/video files, further providing user interface components such as input buttons to click and save as draft or submit when finalized, user interface components to view, edit or share such drafts and/or finalized plans and/or strategies and/or game related materials with other members of their group or other group(s) as may be required, and/or uploading and displaying related advertisements using advertising modules if necessary.

In order to address the needs of sportsmen and those who love to interact with the sportsmen, the event interactivity system (318) and/or any other modules/systems as shown in FIG. 3, could be further customized as may be needed to promote interactivity between sportsmen/women and those attending their events, such as, league games, fundraising events, auction events, or simply having fan clubs, etc. besides providing everything mentioned under event interactivity system and the end-to-end event effective event management, engagement, cross-interactivity empowerment and optimization system as described in any, many or all of the preceding paragraphs above. e.g. the events site building system, the ticketing and registration, the showcases and showcasing module in combination with shops and shopping modules could help such sportsmen/women to showcase, sell, auction their products or services, such as, merchandise, collectibles, audio, video, etc., and offer promotional incentives using the rewards and referral system.

In some embodiments, the end-to-end effective events management, engagement, cross-interactivity empowerment and optimization system (108) could also be referred to as effective sports management, engagement, cross-interactivity empowerment and optimization module/system and could include specific customizations catered to the global sports industry, including but not limited to, by country, by language, by sports kind, etc. The system uses built-in programs, algorithms, codes, etc. to gather and store data inputs from such screens, and is integrated with the User Intelligence Engine (105) and the Auto-matchmaking and marketing engine (118) described above. The pre-event, during-event and post-event could be customized for pre-games, during game day(s) or post-game(s) activities, and/or the invitations, greetings, gifting, schedule and calendar, showcases and showcasing, gallery, shops and shopping systems, referral and rewards system, support systems, dashboard system and communications systems could each be customized and/or used in any, many or all of the embodiments of the sports system (334).

Another embodiment of the invention for the end-to-end effective event management, engagement, cross-interactivity empowerment and optimization includes an innovative method and system called movies system (337), which is primarily for actors/actresses, their fans, their event organizers, including but not limited to, movie makers, movie launch event organizers, movie distributors, the attendees of such events, movie goers and all entities associated with movies, for e.g. movie production houses/producers, movie directors, story writers, screen play, choreographers, cinematographer, stunt artists, dancers, songs and music composers, advertisers, sponsors, exhibitors, theatre owners, theatre artists, speakers, master of ceremonies, other entertainers, guests etc. One of the many process flows of this movies system/module includes, but is not limited to, the system using its built-in programs, algorithms, codes, etc. to combine, or use independently, any, many or all of the modules/systems as shown in FIG. 3 and described in all of the preceding paragraphs above, with any customizations and feature additions as may be required. For e.g. the member interactivity module (319) could be customized to cater to the specific needs of the people associated with movies, including but not limited to, movie stars, movie directors, producers, lyricists, music composers, writers, etc., which could further include interactivity amongst such people associated with movies within a formed group, or belonging to a movie group, cross interactivity amongst actors/actresses, directors, producers, and others in the movie/theatre/dance/drama industry, including those belonging to multiple groups, guilds, or any other group with one or more members.

In some embodiments, the end-to-end effective events management, engagement, cross-interactivity empowerment and optimization system (108) could be referred to as effective movies management, engagement, cross-interactivity empowerment and optimization system, and could include specific customizations catered to global movies industry, including but not limited to, by country, language, genre, etc.

In another such embodiments, the events interactivity system (318) could also be referred to as movies interactivity module/system and could include user interface components to perform movies interactivity activities, such as, but not limited to, those related to movie plans, scripts, screenplays, etc. in the making process, already made or storing and/or viewing collections, further adding, storing or viewing any such collections as specific references, or any other use. The user interface components for such movie plans, movies, direction, production—pre and post, distribution and/or exhibition strategies, could further include, input components, not limited to, for adding, viewing and editing such plans, scripts, strategies or any write-ups and/or collections, such input components further comprising, but not limited to, providing an html editor for text editing purposes of changing colors, fonts, etc., providing touch sensitive interfaces for writing, editing, drawing, recording with touchpads, digital stylus, fingers, etc. for browsing, selecting and uploading a file from a device or computer in use, giving a name(s) to the game plan(s) or strategies thus drafted or uploaded, adding related notes, providing input components to upload, or for recording of, audio, and/or video, and/or audio/video files, further providing user interface components such as input buttons to click and save as draft or submit when finalized, user interface components to view, edit or share such drafts and/or finalized plans and/or strategies and/or game related materials with other members of their group or other group(s) as may be required, and/or uploading and displaying related advertisements using advertising modules if necessary. The system uses built-in programs, etc. to gather and store data inputs from such screens, and is integrated with the User Intelligence Engine (105) and the Auto-matchmaking and marketing engine (118). The pre-event, during-event and post-event could be customized for pre-production, during production or post-production activities, and/or the events site building system, the ticketing and registration system, the invitations, greetings, gifting, schedule and calendar, showcases and showcasing, gallery, shops and shopping systems, referral and rewards system, support systems, dashboard system and communications systems could each be customized or used in any, many or all of the embodiments of the movies system for related purposes.

Another embodiment of the invention for the end-to-end effective event management, engagement, cross-interactivity empowerment and optimization includes an innovative method and system called theme parks world system (339), which is primarily for theme parks and the world of merry associated with such parks. One of the many embodiments of this theme parks system/module includes, but is not limited to, the system using its built-in programs, algorithms, codes, etc. to combine, or use independently, any, many or all of the modules/systems as shown in FIG. 3 and described in all of the preceding paragraphs above, with any customizations and feature additions as may be required. For e.g., the events interactivity system (318) could also be referred to as theme parks world module/system and could include user interface components to perform theme parks interactivity activities, such as, but not limited to, interactivity and/or cross interactivity amongst visitors, guests of the park year round, management of the park(s) worldwide, attendees of event(s) or sub-event(s) happening inside each such park, or multiple such theme parks worldwide under the same management, or different managements.

In another embodiment, the end-to-end effective events management, engagement, cross-interactivity empowerment and optimization system (108) could also be referred to as effective theme parks management, engagement, cross-interactivity empowerment and optimization module/system, and include specific customizations catered to the global theme parks' industry, including but not limited to, by country, by language, by theme park kind, etc. This system uses built-in programs, algorithms, codes, etc. to gather and store data inputs from such screens, and is integrated with the User Intelligence Engine (105) and the Auto-matchmaking and marketing engine (118) described above. The events site building system, the ticketing and registration system, the invitations, greetings, gifting, schedule and calendar, showcases and showcasing, gallery, shops and shopping systems, referral and rewards system, support systems, dashboard system and communications systems could each be customized and/or used in any, many or all of the embodiments of the theme parks world system (339) for related use.

Another embodiment of the invention for the effective end-to-end effective event management, engagement, cross-interactivity empowerment and optimization includes an innovative method and system for an events relationship management system (359). The main objective of this events relationship management system is to create, maintain and nurture the various relationships in the events ecosystem in ways that become a win-win for all parties/entities involved in such an ecosystem, for e.g. organizer, attendees, sponsors, advertisers, suppliers, venue providers, entertainers, speakers, etc. and helps boost their respective revenue generations and maximize return on investments. One of the many embodiments of this system includes, but is not limited to, the system using its built-in programs, algorithms, codes, etc. to gather all the data inputs from several modules as shown in FIG. 3, and further fetching the user intelligence information stored by the User Intelligence Engine, any auto-matchmaking information from the auto-matchmaking and marketing engine, and further providing new relationship creation suggestions to any, many or all parties/entities involved in the events ecosystem. For e.g. the event relationship management system could provide suggestions, via relevant user interface components, to an event organizer who may not have invited several attendees to an event which another similar event organizer(s) may have, and in doing so would create several new relationships that could immensely benefit both that event organizer and such attendees who were invited, and many of those who would have attended, based on such suggestions. Similarly, this system could offer several methods to maintain and nurture such new relationships formed, or existing relationships, via relevant user interface components. For e.g. in one such process flow, this system could suggest based on past attendance, and other data inputs extracted from several other modules of FIG. 3, to offer discounts for repeat attendance or special loyalty incentive programs for attendees or exhibitors who have participated in their yearly events, continuously for several years. In another process flow, as an example, of this embodiment of the event relationship management system, the system could provide user interface components, where an event organizer could choose to provide any, many or all of the relationship maintenance activities, for e.g. creating, sending greetings on birthdays, anniversaries, etc. This system could further include specific customizations catered to the global interests of enterprises and consumers, including but not limited to, by country, by language, by kind of event organizer or attended etc. The system uses built-in programs, etc. to gather and store data inputs from such screens, and is integrated with the User Intelligence Engine (105) and the Auto-matchmaking and marketing engine (118) described above.

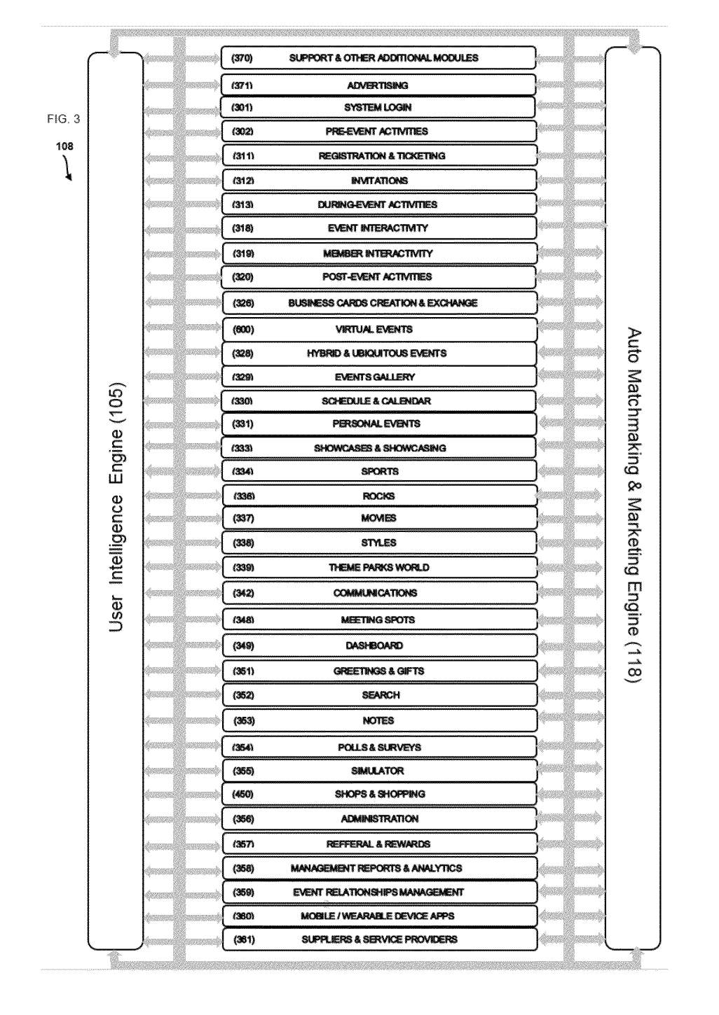

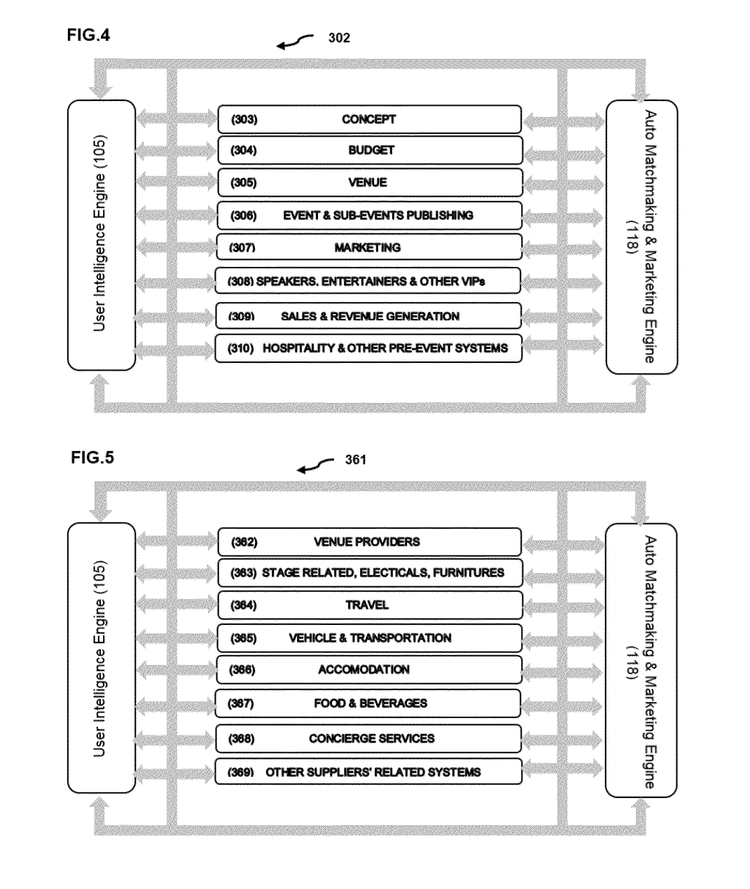

Additional modules of the end-to-end event management, engagement, cross-interactivity empowerment and optimization system (108) could include, but not limited to, auditing and security. Such an auditing and security system/module could be integrated with any, many or all of the modules in FIGS. 3, 4 & 5. Another module could include a collaboration and embedding system that could add collaboration and embedding abilities in any of the systems in FIGS. 3, 4 & 5. Yet another additional module could include a state of the art 3d/multi-dimensional imagery creation system, and providing such features and functions of the system for usage, download or display of such designs in either of any or many backgrounds, screensavers, virtual human and non-human models, videos, websites, documents, and in multiple placeholders across any system including transporting such data via emails to users or to third party servers.

Another embodiment of the invention for the end-to-end effective event management, engagement, cross-interactivity empowerment and optimization system (108), includes an innovative method and system for carrying out the invention as a desktop, a mobile and/or a wearable device application. In this embodiment, the user could be provided with downloadable software(s) application(s), which could then be installed from an interface, such as, a web browser or a third party application store, directly into a device, such as but not limited to, a mobile phone, a wearable device, a computer or any such device in use.

Each of the embodiments of the invention including but not limited to those mentioned above, such as, concept automation system, budget management system, venue management system, events and sub-events addition system, speakers management system, entertainers management system, registration and ticketing system, marketing management system, sales management system, hospitality management system, event site building and management system, events interactivity system, member interactivity system, business cards, creation, storage and exchange system, accommodations management system, meeting spots management system, event search system, notes system, event gallery system, showcases and showcasing system, styles system, scheduling and calendaring system, invitations and greetings system, gifts system, shops and shopping system, virtual events system, hybrid and/or ubiquitous events system, communications system, suppliers system, advertising system, auto-matchmaking engine and marketing system, user intelligence engine system, simulator system, live real-time dashboard system, announcements system, polls system, event updates, news and press management system, survey system, expenses management system, revenue management system, discounts system, referral and rewards system, management analytics and reports system, support system, rocks system, sports system, movies system, events relationship management system, theme parks management system, auditing and security system, collaboration and embedding system, multi-dimensional imagery creation and management system, etc. can be an independent module, a standalone system used within or outside the context of events, in relation to events management, and/or integrated with any of the many modules of the end-to-end effective event management, engagement, cross-interactivity empowerment and optimization system, and/or with third party systems, other software(s) or service(s). The data inputs received from, each of the systems as stated above and described in the various embodiments disclosed, and stored in the relevant data storages can then be retrieved and displayed according to the publishing requests from anywhere inside or outside the system. Each of the systems as stated above could further include user interface components, such as, but not limited to, inputting any business/personal information to be displayed, advertised, published, printed with additional components to distribute, including distribution methods not limited to, online distribution or prints distribution, to customers or any contacts.

The effective end-to-end effective event management, engagement, cross-interactivity empowerment and optimization system could further be customized to utilize the mobile and/or wearable device(s), or any other device specific operating systems, such as, but not limited to, iOS, Android. RIM Blackberry OS, Windows phone, etc.

Many other embodiments of the invention for the end-to-end effective event management, engagement, cross-interactivity empowerment and optimization system could include any, many or all of the above methods and systems described in all of the preceding paragraphs, and referred to in all the accompanying figures, further customized to meet any specific needs of any group and/or event with one or more members. While various embodiments have been described above, it should be understood that they have been presented by way of example only, and not limitation. Thus, the breadth and scope of a preferred embodiment should not be limited by any of the above exemplary embodiments. The methods and systems explained in the present invention can be any, many or all of, but not limited to, local system(s), web-based system(s), mobile native application(s), mobile browser based application(s) or hybrid system(s). The present invention including all of its embodiments is platform independent and device independent. The invention may be performed in either hardware, including, but not limited to, personal computers, MP3 players, cell phones, PDAs, tablets, RFID devices, wearable and non-wearable devices or equipments, location based GPS systems, and devices with video capabilities, software, mobile applications, desktop applications, or any combinations thereof, as those terms are currently known in the art. In particular, the invention may be carried out by software, firmware, or microcode operating on a computer or computers of any type. Additionally, software embodying the invention may comprise computer instructions in any form, e.g. source code, object code, or interpreted code, stored in any computer-readable medium, e.g. ROM, RAM, magnetic media, punched tape or card, compact disc (CD) in any form, and DVD. Furthermore, such software may also be in the form of a computer data signal embodied in a carrier wave, such as that found within the well-known Web pages transferred among computers connected to the Internet.

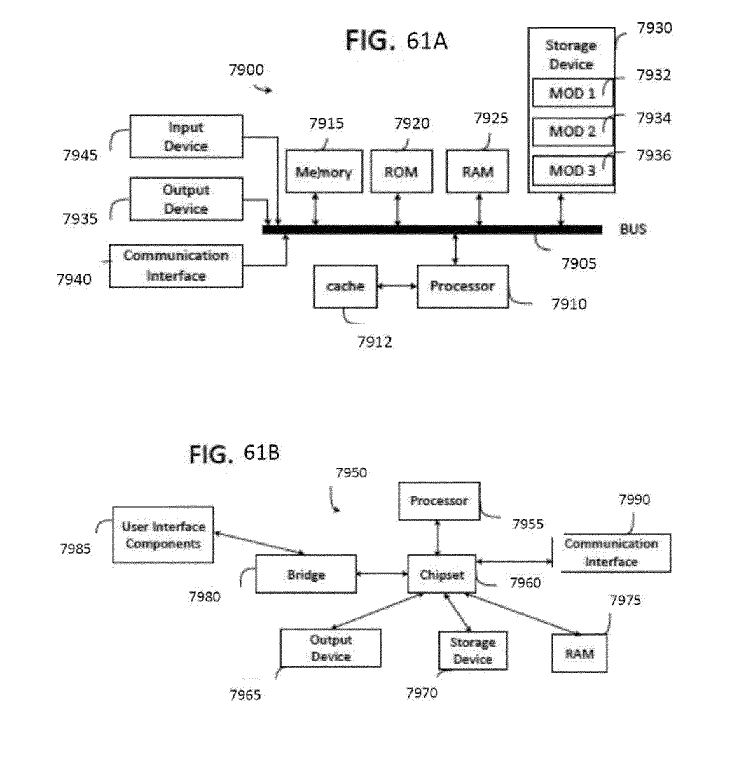

FIG. 61A and FIG. 61B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 61A illustrates a conventional system bus computing system architecture 7900 wherein the components of the system are in electrical communication with each other using a bus 7905. Exemplary system 7900 includes a processing unit (CPU or processor) 7910 and a system bus 7905 that couples various system components including the system memory 7915, such as read only memory (ROM) 7920 and random access memory (RAM) 7925, to the processor 7910. The system 7900 can include a cache of high-speed memory connected directly with, in close proximity to, or integrated as part of the processor 7910. The system 7900 can copy data from the memory 7915 and/or the storage device 7930 to the cache 7912 for quick access by the processor 7910. In this way, the cache can provide a performance boost that avoids processor 7910 delays while waiting for data. These and other modules can control or be configured to control the processor 7910 to perform various actions. Other system memory 7915 may be available for use as well. The memory 7915 can include multiple different types of memory with different performance characteristics. The processor 7910 can include any general purpose processor and a hardware module or software module, such as module 1 7932, module 2 7934, and module 3 7936 stored in storage device 7930, configured to control the processor 7910 as well as a special-purpose processor where software instructions are incorporated into the actual processor design. The processor 7910 may essentially be a completely self-contained computing system, containing multiple cores or processors, a bus, memory controller, cache, etc. A multi-core processor may be symmetric or asymmetric.

To enable user interaction with the computing device 7900, an input device 7945 can represent any number of input mechanisms, such as a microphone for speech, a touch-sensitive screen for gesture or graphical input, keyboard, mouse, motion input, speech and so forth. An output device 7935 can also be one or more of a number of output mechanisms known to those of skill in the art. In some instances, multimodal systems can enable a user to provide multiple types of input to communicate with the computing device 7900. The communications interface 7940 can generally govern and manage the user input and system output. There is no restriction on operating on any particular hardware arrangement and therefore the basic features here may easily be substituted for improved hardware or firmware arrangements as they are developed.

Storage device 7930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 7925, read only memory (ROM) 7920, and hybrids thereof. The storage device 7930 can include software modules 7932, 7934, 7936 for controlling the processor 7910. Other hardware or software modules are contemplated. The storage device 7930 can be connected to the system bus 7905. In one aspect, a hardware module that performs a particular function can include the software component stored in a computer-readable medium in connection with the necessary hardware components, such as the processor 7910, bus 7905, display 7935, and so forth, to carry out the function.

FIG. 61B illustrates a computer system 7950 having a chipset architecture that can be used in executing the described method and generating and displaying a graphical user interface (GUI). Computer system 7950 is an example of computer hardware, software, and firmware that can be used to implement the disclosed technology. System 7950 can include a processor 7955, representative of any number of physically and/or logically distinct resources capable of executing software, firmware, and hardware configured to perform identified computations. Processor 7955 can communicate with a chipset 7960 that can control input to and output from processor 7955. In this example, chipset 7960 outputs information to output 7965, such as a display, and can read and write information to storage device 7970, which can include magnetic media, and solid state media, for example. Chipset 7960 can also read data from and write data to RAM 7975. A bridge 7980 for interfacing with a variety of user interface components 7985 can be provided for interfacing with chipset 7960. Such user interface components 7985 can include a keyboard, a microphone, touch detection and processing circuitry, a pointing device, such as a mouse, and so on. In general, inputs to system 7950 can come from any of a variety of sources, machine generated and/or human generated.

Chipset 7960 can also interface with one or more communication interfaces 7990 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 7955 analyzing data stored in storage 7970 or 7975. Further, the machine can receive inputs from a user via user interface components 7985 and execute appropriate functions, such as browsing functions by interpreting these inputs using processor 7955. It can be appreciated that exemplary systems 7900 and 7950 can have more than one processor 7910 or be part of a group or cluster of computing devices networked together to provide greater processing capability. For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

I claim:

1. A system for optimizing events comprising:
a processor;
a communication interface configured to:
receive past event data from a distributed network of users, the past event data including a plurality of past event details; and
receive a new event request from a user in the distributed network of users, wherein the new event request includes a plurality of new event details;
a non-transitory computer-readable medium storing instructions that, when executed by the processor, cause the system to compare the plurality of past event details to the plurality of new event details and to provide a suggestion to the user for optimizing the new event.
